(19) United States
(12) Patent Application Publication
(10) Pub. No.: US 2026/0289078 A1
(43) Pub. Date: Sep. 24, 2026

(54) SYSTEM

(71) Applicant: SoftBank Group Corp., Tokyo (JP)

(72) Inventor: Masaki KOGO, Tokyo (JP)

(73) Assignee: SoftBank Group Corp., Tokyo (JP)

(21) Appl. No.: 19/562,793

(22) Filed: Mar. 11, 2026

(30) Foreign Application Priority Data
Mar. 19, 2025 (JP) 2025-044912

(51) Int. Cl. G06F 40/166; G06F 40/253; G06F 40/284; G06V 10/82; G06V 40/16; G10L 25/24; G10L 25/63

(52) U.S. Cl. CPC G06F 40/166; G06F 40/253; G06F 40/284; G06V 10/82; G06V 40/174; G10L 25/24; G10L 25/63

(57) ABSTRACT

A system includes a processor, wherein the processor is configured to analyze past behavioral history of a user to identify at least one interest of the user, input a prompt sentence to a generative artificial intelligence model to instruct the generative artificial intelligence model to generate information based on the at least one interest, and neutrally edit the generated information by using natural language processing technology.

### CROSS-REFERENCE TO RELATED APPLICATION

This application is based on and claims priority under 35 USC 119 from Japanese Patent Application No. 2025-044912 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information provision systems that utilize user behavior logs typically recommend existing content such as web pages, news articles, or videos based on simple correlations or collaborative filtering. Such systems often fail to (i) accurately derive the latent interests of each user from heterogeneous past behavioral histories, (ii) generate new content tailored to those interests, and (iii) present the generated content in a neutral and balanced manner. As a result, there is a risk of information overload, biased or sensational presentation of information, and inadequate personalization of the content format and notification timing. Furthermore, when generative artificial intelligence models are used in a straightforward manner, the output may contain biased expressions, redundant details, or low-relevance information, and conventional systems do not sufficiently control these aspects through structured prompts and post-editing. In addition, existing systems generally do not flexibly adjust the frequency and format of notifications about newly generated information in response to individual user settings, thereby reducing user convenience and engagement.

### SUMMARY

In order to solve the above-described problems, a system according to one aspect of the present invention comprises a processor, wherein the processor is configured to analyze past behavioral history of a user to identify at least one interest of the user, input a prompt sentence to a generative artificial intelligence model to instruct the generative artificial intelligence model to generate information based on the at least one interest, and neutrally edit the generated information by using natural language processing technology. In this manner, the processor uses the analysis of the past behavioral history to derive user-specific interests, and uses the prompt sentence to control the generative artificial intelligence model so that the information generation is guided toward those interests. The processor further applies natural language processing technology, such as bias detection, style normalization, and content filtering, to the generated information to remove or mitigate subjective, extreme, or promotional expressions and to present the information in a neutral form. In another aspect, the processor is configured to summarize the generated information by using natural language processing technology and organize the generated information based on importance of the generated information, thereby reducing information overload and presenting key points in a structured manner. In a further aspect, the processor is configured to notify the generated information to a device of the user and adjust at least one of a frequency and a format of the notification based on a setting of the user, thereby enabling the user to receive neutrally edited, interest-based generated information in a manner and timing suitable for the user's preferences.

The term “processor” refers to one or more hardware processing units, such as a central processing unit (CPU), a graphics processing unit (GPU), a digital signal processor (DSP), or a system on a chip (SoC), and may also include associated memory and control circuitry configured to execute instructions to perform specified functions.

The term “past behavioral history of a user” refers to information representing actions performed by the user over time, including at least one of browsing history, search history, content viewing history, application usage history, and communication or posting history on social networking services or other platforms.

The term “interest of the user” refers to a topic, theme, or field that is inferred to be of relevance or preference to the user based on analysis of the past behavioral history of the user, and may include domains such as science, sports, entertainment, technology, or other subject areas.

The term “generative artificial intelligence model” refers to a machine learning model that is trained to generate new content, such as text, images, audio, or multimodal information, in response to input data or instructions, and includes, for example, large language models, generative adversarial networks (GANs), and transformer-based generative models.

The term “prompt sentence” refers to a text input or sequence of tokens provided to the generative artificial intelligence model to specify instructions, constraints, context, or examples, in order to cause the generative artificial intelligence model to generate information in accordance with a desired intent or topic.

The term “generate information” refers to producing new content by the generative artificial intelligence model in response to a prompt sentence, including at least one of natural language text, structured summaries, explanations, or other descriptive information related to an interest of the user.

The term “natural language processing technology” refers to one or more computational techniques or models for analyzing, transforming, or generating human language text, including at least one of tokenization, parsing, sentiment analysis, bias detection, summarization, text classification, and style transfer.

The term “neutrally edit the generated information” refers to processing the generated information by using natural language processing technology so as to reduce or remove subjective, extreme, or promotional expressions, correct inconsistencies, and present the information in a balanced and factual manner without favoring a particular viewpoint.

The term “summarize the generated information” refers to condensing the generated information into a shorter representation that preserves main points and essential facts by using natural language processing technology, including extractive or abstractive summarization.

The term “organize the generated information based on importance” refers to arranging or structuring the generated information such that elements deemed to have higher relevance, significance, or priority, as determined by predefined rules or machine learning models, are emphasized or placed in more prominent positions.

The term “device of the user” refers to any electronic terminal operated by or associated with the user, including at least one of a smartphone, tablet, personal computer, wearable device, or smart television, that is capable of receiving notifications and presenting information.

The term “notify the generated information” refers to transmitting information indicative of the generated information, such as the content itself, a summary thereof, or a link thereto, from the system to the device of the user through at least one communication channel, including push notifications, in-application messages, emails, or similar mechanisms.

The term “frequency of the notification” refers to how often notifications about the generated information are sent to the device of the user within a given time period, such as per hour, per day, or per week.

The term “format of the notification” refers to the presentation style or communication modality of the notification, including at least one of textual notifications, graphical notifications, audio alerts, banners, pop-up messages, and in-application cards or tiles.

The term “setting of the user” refers to configuration information explicitly or implicitly specified by the user, including preferences regarding notification frequency, notification format, content categories, delivery time windows, and other parameters that control how the system provides the generated information to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

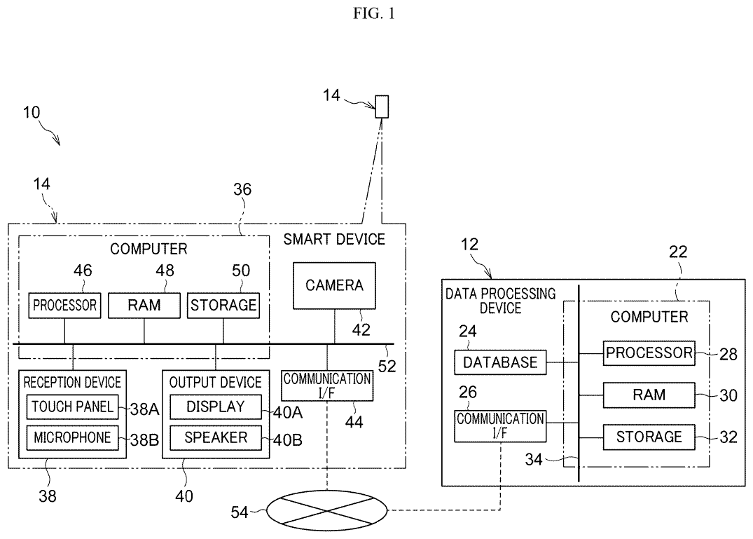

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

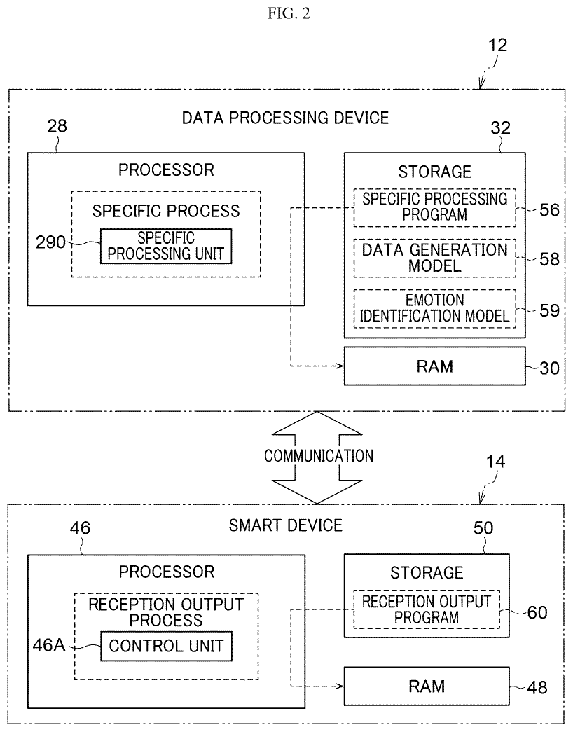

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information delivery systems that attempt to personalize content based on user behavior typically rely on static recommendation rules, coarse-grained interest categories, or simple correlation between accessed items and suggested items. Such systems often treat user behavior logs as opaque inputs to a ranking engine without performing fine-grained linguistic analysis or context-sensitive synthesis of information. As a result, the systems frequently deliver redundant, biased, or poorly structured content that does not efficiently support user understanding of complex topics. Further, existing systems that employ machine learning models for content generation or recommendation often operate as black boxes: they do not explicitly control or expose the structure of input instructions to generative models, do not optimize which portions of collected information are actually supplied to such models, and do not dynamically adapt the instruction parameters based on user feedback. This can lead to technical inefficiencies, such as unnecessary consumption of computational resources and communication bandwidth, as well as technical shortcomings, including degraded relevance, lack of neutrality, and inconsistent formatting of generated outputs. Moreover, many systems handle user behavior data and network-collected data in a loosely coupled fashion. User logs are processed in one subsystem, web crawling is managed by another subsystem, and generative processing is handled separately by yet another service, with minimal coordination among them. This fragmented architecture makes it difficult to optimize end-to-end processing, such as deciding which text segments should be prioritized for summarization, which data should be transmitted to a generative model under token or size constraints, and how to update model instructions when user interaction patterns change. Consequently, the overall computing system may perform redundant text analysis, repeatedly process low-value content, and fail to learn from user feedback in a structured way.

There is therefore a need for a technical solution that integrates behavioral-log analysis, network-side information collection, natural language processing, and generative model control into a coherent processing pipeline. Such a solution should: (i) perform structured extraction of user interest keywords from heterogeneous logs, (ii) construct and maintain an information set aligned with those interests by network retrieval, (iii) compute importance levels of information units and selectively provide them to a generative model through an explicitly constructed prompt sentence, and (iv) dynamically adjust both the information-generation process and notification behavior based on real-time usage states and evaluation information from user terminals. By addressing these technical problems, the computing system can improve the efficiency, controllability, and quality of machine-generated information media delivered to end users.

The specific processing by the specific processing unit 290 of the data processing device 12 in Example 1 is realized by the following means.

The present invention provides a server comprising a processor configured to acquire operation history data, search history data, and communication history data of a user from at least one user terminal over a communication network, to perform linguistic analysis and statistical analysis on character information contained in the acquired history data, and to extract a group of keywords that represent an interest of the user; the processor further configured to execute an information collection process that retrieves related information from a plurality of network-accessible information sources based on the group of keywords and generates an information set including a plurality of information units corresponding to the related information; the processor further configured to apply natural language processing to the information set to compute importance levels of the plurality of information units, to perform preprocessing for summarizing or formatting at least a portion of the information set, and to generate a prompt sentence that explicitly specifies instruction content, an output format, and neutrality conditions for a generative information processing model based on the preprocessed information set and the group of keywords; the processor further configured to provide the prompt sentence and the information set, or a selected subset thereof determined according to the importance levels, as input to the generative information processing model, to receive generated information output by the generative information processing model, and to generate an information medium corresponding to the interest of the user by summarizing or editing the generated information using natural language processing; the processor further configured to generate notification data including identification information of the information medium for distribution to the user terminal and to transmit the notification data to the user terminal via a communication service; and the processor further configured to receive usage state information or evaluation information from the user terminal regarding presentation of the information medium and to update at least one of the group of keywords, the information collection process parameters, and one or more conditions contained in the prompt sentence, including an output length, a structure, and a detail level, based on the usage state information or the evaluation information. This enables an integrated computer-implemented pipeline that efficiently transforms heterogeneous user behavior logs and network-collected content into dynamically optimized prompt sentences and selectively supplied inputs for a generative model, thereby improving computational resource utilization, enhancing control over neutrality and structure of generated outputs, and adapting notification timing and content-generation behavior in response to real-time user interactions to provide technically improved personalized information media.

The term “processor” refers to a hardware computing element, such as a central processing unit or a computing core, that executes machine-readable instructions to perform data acquisition, analysis, generation, and communication operations described in the present specification.

The term “operation history data” refers to information indicating user interactions with an electronic device or software application, including but not limited to page views, button presses, screen transitions, and other recorded usage events.

The term “search history data” refers to information indicating search queries or retrieval requests issued by a user to a search function, search engine, or similar retrieval service, together with associated timestamps or contextual metadata.

The term “communication history data” refers to information indicating exchanges of messages, posts, comments, or other communication content made by or to a user via a communication service, such as a network-based messaging service, social platform, or electronic mail system.

The term “user terminal” refers to an information processing apparatus operated by a user, such as a smartphone, tablet computer, personal computer, or other communication-enabled device capable of executing application programs and exchanging data with a server.

The term “communication network” refers to a wired or wireless data transmission infrastructure, such as a local area network, a wide area network, or a packet-switched public network, that enables communication between the server and external devices or services.

The term “linguistic analysis” refers to a processing operation that interprets character information according to language structure, including at least one of tokenization, morphological analysis, part-of-speech tagging, lemmatization, and syntactic analysis.

The term “statistical analysis” refers to a processing operation that evaluates numerical or frequency-based characteristics of text or other data, including at least one of term frequency calculation, inverse document frequency calculation, co-occurrence analysis, clustering, or topic modeling.

The term “character information” refers to data expressed as a sequence of characters or symbols, including textual elements such as words, sentences, or messages acquired from logs, documents, or network sources.

The term “group of keywords” refers to a set of one or more words, phrases, or token sequences extracted from data and used to represent an interest, topic, or preference associated with a user.

The term “interest of the user” refers to a thematic inclination, preference, or concern of a user inferred from the user's behavior, such as frequently accessed topics, repeated search queries, or recurring themes in communication content.

The term “information collection process” refers to a sequence of operations executed by the processor to retrieve or acquire data from one or more information sources accessible via a communication network based on specified conditions such as keywords.

The term “information source” refers to a provider or repository of data accessible via a communication network, including at least one of a data server, a web site, a document repository, or an application programming interface.

The term “related information” refers to data items, such as documents, records, or messages, that are determined to be associated with one or more keywords or topics representing the user's interest.

The term “information set” refers to an aggregated collection of a plurality of information units, where each information unit is a discrete piece of information such as an article, paragraph, sentence, or snippet collected by the information collection process.

The term “information unit” refers to an individual, addressable component of the information set, including at least one of a document, section, paragraph, sentence, or structured record.

The term “natural language processing” refers to computational techniques for handling human language data, including but not limited to tokenization, parsing, semantic analysis, summarization, sentiment analysis, and text classification.

The term “importance level” refers to a quantitative or qualitative measure assigned to an information unit to indicate its relative significance, relevance, or priority for further processing or presentation.

The term “preprocessing” refers to a set of operations applied to raw or collected data prior to main processing, including at least one of cleaning, normalizing, summarizing, segmenting, or reformatting text or related content.

The term “summarizing” refers to a process of generating a shortened representation of one or more information units while preserving key content or meaning.

The term “formatting” refers to a process of arranging or structuring information, including adding or adjusting headings, sections, lists, or other layout elements to improve readability or machine processing.

The term “prompt sentence” refers to a sequence of characters or instructions supplied as input to a generative information processing model, the sequence specifying at least one of a task description, output conditions, style constraints, and content requirements.

The term “generative information processing model” refers to a machine-learned model configured to generate information, such as text, in response to input data and instructions, including models based on probabilistic, neural, or other generative architectures.

The term “generated information” refers to data output by the generative information processing model in response to the prompt sentence and any additional input content.

The term “information medium” refers to synthesized or processed content prepared for presentation to a user, including but not limited to a text article, a structured summary, or a composite content item generated from collected and processed data.

The term “notification data” refers to information used to cause a user terminal to indicate availability of content, the information including at least one of a title, summary, identifier of an information medium, notification type, and display parameter.

The term “communication service” refers to a service or protocol used to transmit data between the server and a user terminal, including at least one of a push notification service, a messaging service, or a transport protocol layer.

The term “usage state information” refers to data indicating how a user interacts with delivered content or notifications, such as access frequency, viewing duration, response actions, or click records.

The term “evaluation information” refers to feedback data provided directly or indirectly by a user regarding the quality, relevance, or bias of an information medium, including explicit ratings, preference indications, or complaint signals.

The term “setting information of the user” refers to configuration data specified or accepted by the user, such as preferred notification timing, frequency limits, content categories, language preferences, or detail-level preferences.

The term “output length” refers to a constraint or parameter specifying a desired size of content generated by the generative information processing model, such as a number of characters, words, tokens, or sections.

The term “structure” refers to an organization pattern of generated content, including arrangement into segments such as an introduction, main sections, conclusions, headings, and lists.

The term “detail level” refers to a degree of granularity or specificity in generated content, such as whether information is provided in a high-level overview, intermediate explanation, or in-depth technical description.

In one embodiment, a server, at least one terminal, and a user cooperate to implement the claimed system. The server comprises one or more physical processors, such as multi-core central processing units installed in a rack-mounted computer or virtualized computing instances in a cloud environment. The server further comprises volatile and non-volatile memory units, including main memory and persistent storage, and one or more network interfaces connected to a communication network. The terminal comprises a portable information processing device, such as a smartphone or tablet computer, including a processor, memory, a display device, an input interface, and a wireless communication interface. The user operates the terminal to allow acquisition and use of behavior data.

The terminal executes an application program that controls acquisition of operation history data, search history data, and communication history data of the user. The terminal uses hardware components such as a mobile processor and flash memory and uses software components such as a web browser, a search application, and a social communication application. The terminal acquires operation history data representing page transitions, button activations, and view displays, search history data representing search queries issued to a search server, and communication history data representing text contents of posts, messages, and comments. The terminal stores these data items in a local storage structure, for example a relational table in a lightweight embedded database, where each record includes at least a timestamp, an identifier of the application, a text field, and a category code.

The terminal performs initial text normalization of the stored text fields by converting characters to a unified character set, such as UTF-8, and replacing certain control characters with standardized separators. The terminal then transmits at least a portion of the normalized records to the server over the communication network using an encrypted transport protocol.

The server receives the transmitted records and stores them in a server-side data repository. The server uses a structured data model in which each user is associated with a user profile structure and a plurality of behavior log entries. Each behavior log entry includes fields for a user identifier, a log type (operation, search, or communication), a text value, a timestamp, and optional additional metadata such as a content category or a device type. The server indexes these fields for efficient retrieval by a database management system.

The server performs linguistic analysis and statistical analysis on character information contained in the behavior log entries to extract a group of keywords that represents an interest of the user. The server executes a linguistic analysis component implemented using a natural language processing library, such as a morphological analyzer and a part-of-speech tagger. The server tokenizes each text value into tokens, assigns a part-of-speech label to each token, and performs lemmatization to normalize different inflected forms to a canonical base form. The server then executes a statistical analysis component that computes frequency statistics and co-occurrence metrics for tokens and token pairs. The server calculates at least one of term frequency, inverse document frequency, and pointwise mutual information values across the user's logs and optionally across a background corpus stored in the server.

The server aggregates the statistical values into a topic representation. In one embodiment, the server applies a topic modeling algorithm, such as a probabilistic latent topic model, to obtain for each user a topic distribution vector and a set of topic descriptors. The server selects tokens and phrases that satisfy predetermined thresholds on frequency, distinctiveness, and topic probability and stores them as a group of keywords for the user. The server stores the group of keywords in a user-interest structure, which associates each keyword with a weight value indicating an importance level for that keyword.

The server executes an information collection process based on the group of keywords. The server controls a web-crawling subsystem, implemented using a crawler framework, to access network-accessible information sources. The server configures the crawler to issue HTTP or HTTPS requests to multiple predetermined network domains, such as news sites, technical document repositories, and resource portals, using URLs constructed from the keywords. The crawler parses received network documents using an HTML or structured-text parser and extracts structured data items including titles, main text, publication dates, and source identifiers. The server stores each extracted document as an information unit in an information set associated with the user and the corresponding keyword. The information set uses a data structure that contains a list of information units, where each information unit includes fields for a document identifier, a keyword identifier, a plain-text body, a timestamp, and a source reliability score.

The server applies natural language processing to the information set to compute importance levels of the plurality of information units. In one embodiment, the server converts each information unit into a vector representation using a feature-extraction model such as a sentence embedding model. The server then computes similarity scores between the embedding of the user's keyword vector and the embeddings of the information units. The server also evaluates the recency of each information unit from its timestamp and the reliability of its source from a preconfigured reliability table. The server combines these measures into an importance score using a weighted formula stored in a configuration module.

The server pre-processes at least a portion of the information set. The server selects information units whose importance scores exceed a threshold or belong to a top-ranked subset. The server then applies a multi-stage summarization pipeline. In a first stage, the server performs extractive summarization of each selected information unit using a sequence-ranking model, which computes a salience score for each sentence in the unit and selects a subset of sentences. In a second stage, the server groups sentences from multiple information units into clusters based on semantic similarity and time proximity, thereby forming subtopic groups. The server then constructs a condensed representation of each subtopic group by selecting representative sentences and generating bullet-point summaries using rule-based linguistic simplification.

The server generates a prompt sentence on the basis of the preprocessed information set and the group of keywords. The prompt sentence is a structured text that includes multiple segments: a role description segment specifying that the model should act as a neutral summarization assistant, a task specification segment describing the required type of summary, a constraint segment defining target length, structure, and neutrality requirements, and a content segment embedding the condensed representations of the information units. The server arranges the segments in a predetermined template, with delimiters to separate instruction text from content text. By generating the prompt sentence with explicit structure, the server ensures that the generative AI model receives clear and machine-optimized instructions rather than an unstructured concatenation of user data.

In one example, the server generates a prompt sentence as follows:

“The user is interested in ‘environmental issues’ and ‘climate change.’

You are a neutral news summarization assistant.

Using the following article summaries, generate an information medium that:
1. Explains the latest developments in environmental policy and climate technology.
2. Presents multiple viewpoints fairly, without taking sides.
3. Uses clear and simple English for a general audience.
4. Is approximately 1,000 words long.

Structure the output with an introduction, three main sections, and a conclusion.

Avoid promotional language for any specific company or country.

Article summaries:
[Summary 1: . . . ]
[Summary 2: . . . ]
[Summary 3: . . . ]”

In another example, the server generates a prompt sentence:

“The user is interested in ‘environmental issues’ and ‘renewable energy.’

Using the provided news snippets, generate an information medium that explains the latest trends in global environmental policy, major technological innovations in renewable energy, and their potential impact on everyday life.

Write in neutral tone, avoid promotion of specific entities, and structure the output with headings and short paragraphs.

Length: approximately 800 words.

Input texts:
[Snippet 1: . . . ]
[Snippet 2: . . . ]
[Snippet 3: . . . ]”

The server provides the prompt sentence and at least a selected subset of the information set as input to a generative AI model executed by a model-serving subsystem. In one embodiment, the generative AI model is implemented as a neural network with a transformer architecture, comprising a plurality of self-attention layers, feed-forward layers, and normalization layers. The server stores model parameters in memory and loads them into the model-serving subsystem, which operates on one or more accelerators, such as graphics processing devices, or on optimized CPU instructions. The server configures the generative AI model with parameters such as maximum token length, temperature, and top-k or top-p sampling thresholds. The server encodes the prompt sentence and the selected information units into token sequences using a subword tokenizer. The server constructs a model input structure that includes a sequence of tokens and position encodings. The server forwards this structure through the transformer layers, where each self-attention layer computes attention weights based on scaled dot products between query, key, and value vectors derived from the token embeddings. The server then applies the feed-forward layers and normalization layers to produce a sequence of output vectors, which the model converts to probability distributions over a token vocabulary at each generation step. The server samples tokens according to the configured parameters and concatenates them into a generated text sequence.

The server receives the generated text sequence as generated information. The server then post-processes this generated information using natural language processing to generate an information medium. The server performs consistency checks on headings and section boundaries, adjusts paragraph breaks, and removes redundant phrases by applying rule-based pattern matching. The server may also compute a readability measure and, if the measure falls outside a desired range, apply a rewriting operation by constructing a secondary prompt sentence that instructs a secondary generative processing to simplify or elaborate specific sections.

The server stores each information medium in a content repository. The content repository maintains a data record for each information medium, including fields for a user identifier, the text of the information medium, an associated set of keywords, a generation timestamp, and version information for the generative AI model and summarization components used. The server indexes these records for efficient retrieval when delivering content to terminals.

The server generates notification data to cause the terminal to indicate availability of the information medium. The server constructs a notification structure including a title derived from the information medium, a short preview extracted from the initial segment of the medium, and an identifier that specifies the corresponding record in the content repository. The server transmits the notification data to the terminal using a communication service, such as a push notification service. The server formats the notification data in a protocol format expected by the communication service and sends it using a secure network connection.

The terminal receives the notification via its operating system's notification subsystem. The terminal displays a visual indication of the notification on a display device. When the user interacts with the notification, the terminal communicates with the server to request the corresponding information medium by transmitting the identifier. The server returns the content in a structured response. The terminal renders the content in a viewer application, controlling the display of headings, paragraphs, and lists based on formatting annotations embedded in the response.

The user can provide usage state information and evaluation information via user-interface controls. The terminal monitors user interactions such as opening, scrolling, and closing of the information medium and transmits usage state information, including access count, reading duration, and skip behavior, to the server. The terminal further presents buttons or sliders for explicit evaluation, such as “relevant,” “not relevant,” or rating scales, and transmits the evaluation information to the server with context information indicating which information medium is being evaluated.

The server uses the usage state information and evaluation information to update the group of keywords, the parameters of the information collection process, and the conditions contained in the prompt sentence. The server adjusts the weights of keywords by increasing weights of keywords associated with frequently accessed media and decreasing weights of keywords associated with quickly abandoned media. The server modifies thresholds used in the statistical analysis to refine which tokens qualify as interest-representing keywords. The server also adjusts parameters of the importance-score calculation formula, thereby controlling which information units are deemed more relevant for future information sets.

The server modifies templates used to construct the prompt sentence by changing parameters such as target output length, degree of detail, and requested structure, based on the user's reading duration and evaluation feedback. For example, if a user typically spends brief periods reading but positively evaluates shorter summaries, the server adjusts the prompt sentence to request shorter, high-level summaries. The server thereby changes the instructions provided to the generative AI model in a way that is technically coordinated with the measured usage state, rather than simply following static configurations.

This architecture yields technical effects that go beyond mere automation of human tasks. The server reduces communication-bandwidth usage and computational load on the generative AI model by pre-selecting and pre-summarizing information units using the importance scores and the two-stage summarization pipeline before transmitting them or embedding them into the prompt sentence. The server improves latency and throughput of content generation because only high-value content is forwarded to the model, and because the prompt sentence is compressed into a structure optimized for machine processing rather than for human reading. The server improves the precision and neutrality of generated content because the server provides explicit neutrality conditions and output-structure constraints in the prompt sentence, and because the preprocessing stage eliminates low-quality or biased sources before model invocation.

In one training embodiment, the server updates internal parameters of the importance-scoring model and the summarization components using supervised or semi-supervised learning. The server stores logs of prior information sets, prompt sentences, generated media, and user evaluation information. The server defines a loss function that penalizes mismatches between predicted importance scores and actual user engagement metrics, and uses gradient-based optimization to update the weights of the sentence embedding model or scoring model. The server may augment training data through data augmentation techniques, such as paraphrasing sentences or reordering content, to improve robustness.

In a further variation, the server can employ different generative AI models with different architectures or sizes and select one based on system load or content type. The server may maintain a smaller model for quick generation of short notifications and a larger model for detailed long-form media. The server selects an appropriate model and adjusts the prompt sentence accordingly. This flexible model selection contributes to technical advantages, including reduced processing time under heavy load and improved quality when resources allow.

In another embodiment, the terminal performs a portion of the preprocessing to offload work from the server. The terminal may implement a lightweight keyword-extraction module and initial summarization module using on-device natural language processing libraries. In this case, the terminal sends already condensed summaries to the server, thereby reducing network traffic and enabling faster responses. The server then performs final importance scoring and generative processing using these condensed units. This division of labor between terminal and server provides an additional technical effect of reducing peak server load and improving responsiveness for users with constrained network connections.

Alternative embodiments may vary in terms of data structures and algorithms employed while remaining within the scope of the claimed system. For example, the server may replace a probabilistic topic model with a clustering algorithm over sentence embeddings for keyword grouping, or may replace the two-stage summarization with a single-stage encoder-decoder model guided by explicit weights derived from usage state information. The essential feature is that the server coordinates extraction of a group of keywords from heterogeneous behavior data, formation and scoring of an information set from network sources, construction of a structured prompt sentence including explicit constraints, and adaptive updating of processing parameters based on feedback, all implemented by concrete computational modules and data structures on specific hardware.

By structuring the system as described above, the server and the terminal collectively improve computer technology by introducing specialized data structures for user-interest modeling and information sets, by applying layered text processing and neural generation in a resource-aware manner, and by dynamically adjusting computational parameters based on measured usage behavior. This provides measurable improvements in processing speed, communication efficiency, and content quality compared to systems that merely apply a generative AI model to raw user data without the described technical integrations and optimizations.

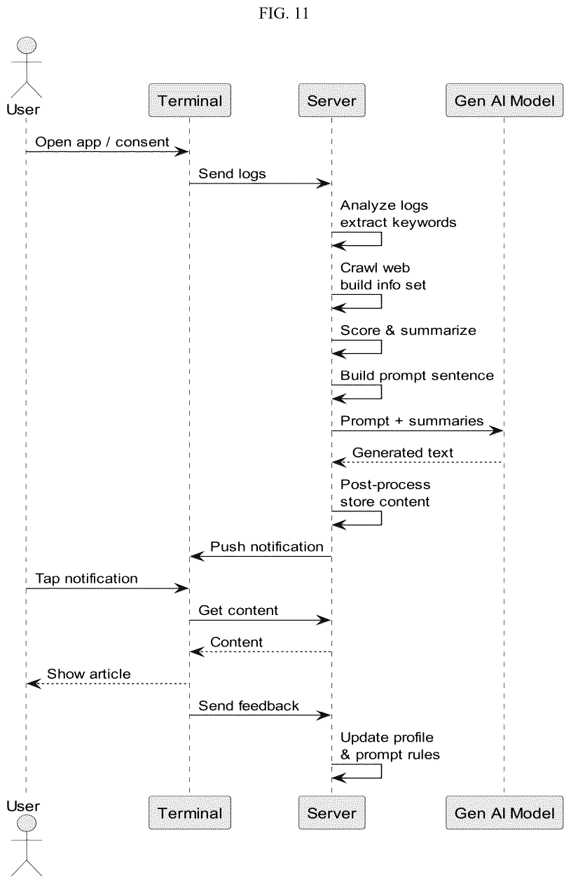

The following describes the processing flow using FIG. 11.

Step 1:

The user installs and launches an application on the terminal.

The terminal receives an installation package from an application distribution service as input and writes the application code and configuration data into local storage as output. The terminal then executes the application binary and displays an initial screen that prompts the user to grant permissions for collecting operation history data, search history data, and communication history data. The user provides input by selecting consent options on the display, and the terminal stores a permission flag and user settings in a local configuration file as output.

Step 2:

The terminal collects raw behavior logs from multiple applications.

The terminal receives, as input, internal event data from a browser, a search application, and a communication application via operating-system APIs or application-specific interfaces. The event data include visited URLs, page titles, search queries, and text messages with timestamps. The terminal performs data aggregation by normalizing timestamps, attaching application identifiers, and converting all text to a unified character encoding, and it writes the aggregated records into a local log table as output.

Step 3:

The terminal transmits normalized behavior logs to the server.

The terminal takes the local log table as input and selects records that fall within a predetermined time window or size threshold. The terminal serializes the selected records into a structured payload, such as a JSON-formatted message, and encrypts the payload using a session key. The terminal then sends the encrypted payload to the server over a secure communication channel and receives an acknowledgment message as output, which the terminal stores as a transmission log.

Step 4:

The server stores behavior logs and prepares them for analysis.

The server receives the encrypted payload from the terminal as input and decrypts the payload using a corresponding session key. The server parses the structured data into individual log entries and validates required fields, such as user identifier, log type, and text content. The server writes the validated entries into a behavior-log database table as output, with indexes on user identifier and timestamp to support efficient retrieval.

Step 5:

The server performs linguistic preprocessing on log texts.

The server retrieves, as input, all behavior-log entries for a given user from the behavior-log database. The server extracts text fields and runs tokenization, part-of-speech tagging, and lemmatization using a natural language processing library. Based on the tagged tokens, the server removes stopwords and low-information tokens. The server then stores, as output, a token sequence list for each log entry in an intermediate linguistic-analysis table that links original entries to their processed tokens.

Step 6:

The server computes keyword statistics and extracts a group of keywords.

The server takes the token sequences for all entries of the user as input and calculates term-frequency values and inverse-document-frequency values for each token. The server computes TF-IDF scores and optionally co-occurrence scores for token pairs, then applies a threshold or ranking function to select tokens and n-grams that are highly representative of the user's behavior. The server groups selected tokens into candidate topics using a clustering or topic-modeling algorithm and creates, as output, a group of keywords with associated weight values, which it stores in a user-interest profile structure.

Step 7:

The server schedules and configures information collection tasks based on the group of keywords.

The server reads the user-interest profile as input and selects a subset of keywords with the highest weight values. For each selected keyword, the server generates query parameters and target source identifiers, such as specific domains or content categories. The server then creates crawl-task objects containing the user identifier, keyword, query parameters, and scheduling information, and inserts these objects into a task queue as output for subsequent crawling.

Step 8:

The server performs web crawling and collects an information set.

The server retrieves crawl-task objects from the task queue as input and sends HTTP or HTTPS requests to network-accessible information sources indicated in the tasks. The server receives HTML pages or structured responses as raw content and parses them using an HTML or markup parser to extract titles, main text bodies, dates, and source identifiers. For each crawled document, the server constructs an information unit record and writes it into an information-set database table as output, linking each information unit to the corresponding user identifier and keyword.

Step 9:

The server calculates importance levels for information units.

The server takes, as input, all information units associated with a given user and a given group of keywords from the information-set database. The server represents each information unit as a numerical vector using a feature-extraction model, and it retrieves keyword vectors and source reliability values. The server computes an importance score for each information unit by combining similarity between vectors, recency derived from timestamps, and source reliability via a weighted formula. The server stores the importance scores in an importance-score field of the information-set table as output.

Step 10:

The server pre-summarizes and structures information units.

The server selects information units with the highest importance scores as input. For each selected unit, the server splits the text into sentences and applies a sentence-ranking algorithm that scores sentences according to centrality and coverage. The server then selects top-ranked sentences to construct an extractive summary for each unit. The server further clusters sentences across units to form subtopic groups and creates, as output, a structured summary dataset that includes per-unit summaries and grouped bullet points, which it stores in a preprocessed-information table.

Step 11:

The server generates a structured prompt sentence for a generative AI model.

The server retrieves the group of keywords and the structured summary dataset as input. The server fills a prompt template that includes a role description segment, a task specification segment, constraint segments for length, structure, and neutrality, and a content segment consisting of the structured summaries. The server concatenates these segments with designated delimiters to create a single prompt sentence string. The server stores this prompt sentence as output in a prompt-log table linked to the user and the targeted information set.

Step 12:

The server invokes the generative AI model with the prompt sentence and preprocessed content.

The server takes the prompt sentence and a selected subset of preprocessed summaries as input and converts them into token sequences using a tokenizer. The server passes these tokens into a transformer-based generative AI model, which consists of multiple stacked self-attention and feed-forward layers. At each layer, the server executes matrix multiplications to compute attention scores and intermediate hidden representations. The model outputs a sequence of probability distributions over tokens at each generation step. The server samples or decodes tokens based on predetermined parameters, assembles them into a generated text sequence, and records this sequence as generated information in a generation-result table as output.

Step 13:

The server post-processes the generated information to create an information medium.

The server reads the generated text sequence as input and performs structural analysis by detecting headings, paragraphs, and list patterns using rule-based text parsing. The server checks for redundancy and incoherent segments, possibly splitting or merging paragraphs and normalizing punctuation. The server then attaches metadata, such as a title, keyword tags, and a creation timestamp, to the cleaned text and writes the finalized information medium into a content repository as output.

Step 14:

The server generates notification data for the terminal.

The server takes the content repository record as input and extracts a title and a short preview segment from the information medium. The server creates a notification payload that includes the extracted title, the preview, a unique content identifier, and optional category information. The server formats this payload according to the specification of a push-notification service and stores the formatted payload as notification data in a notification queue as output.

Step 15:

The server transmits notification data via a communication service.

The server retrieves the notification data and the corresponding device token of the terminal as input. The server establishes a secure network connection to a push-notification gateway and sends the notification payload, including the device token, over the connection. The server receives a delivery status response from the gateway and records the status in a notification-log table as output.

Step 16:

The terminal receives the notification and requests the information medium.

The terminal takes, as input, the notification payload delivered by the push-notification service through the operating system. The terminal displays a notification entry containing the title and preview text on the device's screen. When the user selects the notification, the terminal extracts the content identifier from the payload and sends a content-request message to the server. The terminal receives, as output from the server, a content-response message that contains the full information medium and associated metadata.

Step 17:

The terminal renders the information medium for the user.

The terminal parses the content-response message as input and separates the title, headings, paragraphs, and lists based on markers in the response. The terminal applies a layout engine to map these structural elements onto the display, handling line breaks, font sizes, and scrollable areas. The terminal generates, as output, a visual presentation of the information medium on the display for the user to read and interact with.

Step 18:

The user provides usage state information and evaluation information through the terminal.

The user interacts with the rendered information medium by scrolling, closing, or pressing evaluation controls. The terminal records interaction events and explicit ratings as input signals. The terminal aggregates reading duration, scroll depth, and evaluation choices into compact usage-state records and evaluation records. The terminal transmits these records to the server, which stores them in a feedback database as output.

Step 19:

The server updates the user-interest profile and prompt-generation parameters.

The server reads the feedback records and existing user-interest profile as input. The server adjusts keyword weights by increasing weights for keywords related to frequently read and highly rated media and decreasing weights for keywords linked to quickly abandoned or poorly rated media. The server recalculates thresholds for keyword selection and modifies coefficients in the importance-score formula. The server also updates prompt-generation templates, such as preferred output length and level of detail, based on aggregated reading patterns. The server stores the updated user-interest profile and revised template parameters as output for use in subsequent executions of Steps 7 through 13.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content personalization systems typically rely on relatively simple recommendation logic, such as keyword matching, collaborative filtering, or static profile rules, that merely select existing content items from a repository. Such systems do not dynamically generate documentary-style media tailored to an individual user's evolving interests, and therefore cannot provide deeply personalized explanatory content with an appropriate structure, length, and tone. In addition, conventional systems generally treat prompt sentences for generative AI models as fixed or manually crafted instructions, without systematically deriving such prompt sentences from a machine-readable user interest model that is updated over time based on user feedback. Further, in existing architectures, the process of transforming generated text into consumable multimedia is often decoupled from the user modeling and generation process. As a result, the medium type, narrative structure, and presentation format are not optimally adapted to the user's behavior patterns, device conditions, and communication environment. This leads to inefficiencies such as overlong or irrelevant outputs, unstable quality of generated content, and an increased computational and network burden without a corresponding improvement in user benefit. Moreover, conventional logging and feedback mechanisms typically capture viewing history, but do not close the loop by using such telemetry as a first-class input to adjust both the internal user interest representation and the configuration conditions of prompt sentences for subsequent generative AI inference. This lack of a feedback-driven control loop prevents the system from converging toward more accurate and efficient generations over time.

Accordingly, there is a need for a computer-implemented technique that improves the underlying information processing by: (i) automatically extracting and structuring user interests from heterogeneous text-based behavior and communication information; (ii) constructing and updating prompt sentences for generative AI models based on a machine-understandable interest representation; (iii) editing generated information automatically to enforce neutrality, structural consistency, and length control; (iv) programmatically converting such edited information into documentary-style medium data adapted for distribution and playback; and (v) feeding back viewing history information and evaluation information from user terminals to update both the interest representation and the generative control parameters. By improving these internal computations and control flows, the overall computer system can generate, deliver, and refine personalized documentary media in a more efficient, scalable, and technically robust manner.

The specific processing by the specific processing unit 290 of the data processing device 12 in Application Example 1 is realized by the following means.

The present invention provides a server comprising a processor configured to acquire user behavior information and communication information, to execute character string normalization processing and phrase extraction processing on text information including the user behavior information and the communication information, and to generate interest information including phrases indicating a user interest target and an interest level associated with each of the phrases; to select, based on the interest information, a template that defines a type and a structure of a document medium or a video medium to be presented to a user, and to construct a prompt sentence to be input to a generative AI model by embedding, into the template, instruction information including request contents for explanation, structural requirements, and expression conditions in accordance with the user interest target and the interest level; to input the prompt sentence to the generative AI model, to acquire generated information including personalized explanatory information corresponding to the user interest target, and to edit the generated information by using natural language processing so that the generated information has a neutral expression and a predetermined length while verifying the generated information for each structural unit; to execute voice generation processing and image selection processing or video composition processing on the edited generated information, to generate medium data in a documentary format corresponding to the user interest target, to convert the medium data into distribution data, and to provide the distribution data to a user terminal via a communication network; and to acquire viewing history information and evaluation information transmitted from the user terminal, and to update the interest information and configuration conditions of the prompt sentence based on the viewing history information and the evaluation information. This enables improvement of computer functionality by implementing an integrated, feedback-driven pipeline in which the server automatically derives and updates machine-readable user interest representations, programmatically constructs and adjusts prompt sentences for the generative AI model, enforces structural and length constraints through post-generation natural language processing, generates and distributes documentary-style media optimized for user terminals and network conditions, and refines subsequent generations based on observed viewing behavior and evaluations, thereby achieving more efficient and accurate operation of the information processing system itself.

The term “user behavior information” refers to information indicating activities performed by a user in relation to one or more information processing devices, including but not limited to browsing history, search history, content viewing logs, application usage logs, and interaction events such as selections, clicks, scrolls, and playback operations.

The term “communication information” refers to information exchanged between a user and one or more communication services or information processing devices, including but not limited to messages, posts, comments, reactions, and metadata associated with such communications.

The term “text information” refers to information expressed in a character-based form, including but not limited to titles, body texts, queries, messages, and descriptions, that can be subjected to natural language processing, character string processing, or other linguistic analysis.

The term “character string normalization processing” refers to processing that converts text information into a normalized representation, including but not limited to converting character types, unifying character case, removing or standardizing symbols, and eliminating elements such as markup tags or control characters.

The term “phrase extraction processing” refers to processing that identifies and extracts words, phrases, or expressions from text information, including but not limited to tokenization, part-of-speech based extraction, and keyword extraction techniques.

The term “interest information” refers to structured information representing one or more user interest targets, including phrases indicating topics or themes of interest and one or more values indicating a degree or level of interest associated with each topic or phrase.

The term “user interest target” refers to a topic, theme, or subject matter that is inferred to be of interest to a user, based on analysis of user behavior information and communication information.

The term “interest level” refers to a quantitative or qualitative indicator associated with a user interest target, representing a degree of the user's interest in that target, for example as a score, rank, or classification.

The term “template” refers to a data structure or pattern that defines at least one of a type, structure, or format of an output medium, and that includes one or more placeholders or fields to be filled with instruction information, user-specific information, or topic-specific information.

The term “document medium” refers to a medium in which information is presented primarily in textual or text-plus-image form, including but not limited to articles, scripts, transcripts, or electronic documents.

The term “video medium” refers to a medium in which information is presented in a time-series image and audio format, including but not limited to video files, streaming video content, and animated visual presentations.

The term “prompt sentence” refers to an instruction sequence, expressed in a natural language or a structured representation, that is provided as input to a generative AI model to control or guide the content, style, structure, or other characteristics of generated information.

The term “generative AI model” refers to a computational model implemented by an information processing apparatus that, in response to an input including a prompt sentence, generates new information such as text, audio, or images, based on learned parameters obtained from training data.

The term “instruction information” refers to information specifying one or more requirements or constraints for generation processing by a generative AI model, including but not limited to explanation requirements, structural requirements, expression conditions, style conditions, and length constraints.

The term “request contents for explanation” refers to a portion of instruction information specifying what subject matter, points, or aspects are to be explained or described by generated information.

The term “structural requirements” refers to a portion of instruction information specifying an organization or layout of generated information, including but not limited to divisions into chapters, sections, subsections, or scenes.

The term “expression conditions” refers to a portion of instruction information specifying linguistic or stylistic constraints on generated information, including but not limited to tone, neutrality, level of technical detail, and target audience level.

The term “generated information” refers to information output by a generative AI model in response to an input including a prompt sentence, the information including at least personalized explanatory information related to a user interest target.

The term “personalized explanatory information” refers to explanatory content generated so as to correspond to one or more user interest targets and to be adapted to user-specific conditions such as interest level, knowledge level, or behavior pattern.

The term “natural language processing” refers to computational processing applied to text information expressed in natural language, including but not limited to tokenization, parsing, semantic analysis, sentiment analysis, summarization, and style transformation.

The term “structural unit” refers to a subdivision of generated information, including but not limited to paragraphs, sections, chapters, scenes, or other discrete segments used for organization and verification.

The term “voice generation processing” refers to processing that converts text information into audio data representing speech, using a speech synthesis or text-to-speech technique.

The term “image selection processing” refers to processing that selects one or more still images corresponding to a topic, phrase, or segment of text, including but not limited to retrieval from a storage device or a content repository based on keywords or metadata.

The term “video composition processing” refers to processing that combines at least one of images, video clips, audio data, subtitles, or other media elements into time-series video data according to a predetermined or dynamically determined structure.

The term “medium data in a documentary format” refers to medium data in which explanatory or narrative content is organized in a documentary style, including an introduction and one or more structured segments that provide factual, explanatory, or narrative information about a user interest target.

The term “distribution data” refers to medium data converted into a format suitable for transmission and playback over a communication network, including but not limited to encoded files, streaming segments, and associated control information.

The term “communication network” refers to an infrastructure that enables data communication between the server and one or more user terminals, including but not limited to the Internet, local area networks, wireless networks, or combinations thereof.

The term “user terminal” refers to an information processing apparatus operated by a user and capable of receiving, decoding, and presenting distribution data, including but not limited to mobile terminals, head-mounted devices, and general-purpose computing devices.

The term “viewing history information” refers to information indicating how a user interacts with medium data, including but not limited to playback events, viewing durations, completion rates, seek operations, and interruption events.

The term “evaluation information” refers to information indicating an explicit or implicit evaluation of medium data by a user, including but not limited to ratings, feedback inputs, preference selections, or inferred satisfaction measures.

The term “configuration conditions of the prompt sentence” refers to parameters or settings that influence construction of a prompt sentence, including at least one of selected templates, explanation requirements, structural requirements, expression conditions, and length conditions.

The term “importance index” refers to a value or metric that indicates a relative importance of portions of text information, and that is used to control summarization, selection, or hierarchical arrangement of such text information.

The term “explanatory structure” refers to an organization of explanatory content into a hierarchy of units such as chapters, sections, or subsections, and to relationships among these units, as used for presenting medium data.

The term “user setting information” refers to information indicating one or more user preferences or configurations related to notification, content presentation, or interaction behavior, including but not limited to preferred notification times, frequencies, and medium types.

The term “communication state information” refers to information indicating a state or condition of a communication path between the server and a user terminal, including but not limited to bandwidth, latency, error rates, and connectivity status.

The term “medium type” refers to a category or modality of output medium, including but not limited to text-based media, audio media, video media, or combinations thereof.

The term “presentation format” refers to a manner in which distribution data or generated information is presented on a user terminal, including but not limited to on-screen layouts, player modes, notification styles, and interaction interfaces.

In one embodiment, a server cooperates with a terminal operated by a user to generate and deliver personalized documentary-style media based on user interests. The server is implemented as an information processing apparatus that includes at least one processor, a memory, a storage device, a network interface, and, in some embodiments, a hardware accelerator such as a graphics processing unit. The terminal is implemented as a user information processing apparatus, such as a mobile terminal or a head-mounted device, that includes a display, an audio output device, local storage, and a communication interface.

The server executes an operating system such as a general-purpose server operating system and runs one or more application programs implemented, for example, in a high-level language environment. The server uses a database management system such as a relational database to store user behavior information, communication information, interest information, templates, generated information, and medium data metadata. The server optionally uses a vector database or an extension to store high-dimensional vector representations used for interest modeling.

The server acquires user behavior information from the terminal and external services. The terminal records interaction events, including page views, scrolling, content selection, playback start and stop events, and explicit feedback such as rating operations, and periodically transmits logs to the server through a secure communication protocol. The server also acquires communication information from external communication services through their programming interfaces, using credentials authorized by the user. The server stores the acquired logs as text information and associated metadata in structured tables, such as a log table containing user identifiers, timestamps, device identifiers, and text fields.

The server processes the text information using natural language processing software libraries. The server performs character string normalization processing by converting text to a unified character set, removing markup tags, URLs, and control characters, and transforming all letters to a single case. The server applies phrase extraction processing using tokenization and part-of-speech tagging to identify nouns, noun phrases, and multi-word expressions. The server computes term statistics across the log entries and generates interest information that includes phrases indicating user interest targets and interest levels associated with each phrase. The interest level is computed based on features such as occurrence frequency, recency, content dwell time, and co-occurrence with other phrases.

The server represents extracted phrases and interest targets by using a neural network-based embedding model. In one embodiment, the server uses a transformer-based encoder network deployed on a hardware accelerator. The network includes multiple self-attention layers, with learnable weight matrices for query, key, and value projections, and feedforward sublayers with non-linear activation functions. The server feeds each phrase as a token sequence to the encoder, obtains a fixed-dimensional vector representation from the final hidden layer, and stores the vector as part of the interest information. The server maintains a user-specific interest vector as a weighted sum of phrase vectors, using the interest levels as weights. By maintaining these vector representations, the server enables fast similarity computation and clustering for interest modeling, improving the computational efficiency relative to naive keyword-only approaches.

The server selects a template that defines a type and a structure of an output medium based on the interest information. The server stores multiple templates in a template storage region, where each template specifies, for example, whether the medium is a document medium or a video medium, a desired duration, a section hierarchy, and stylistic constraints. The server determines a template by comparing the current interest vector with template descriptors, and by referencing user setting information and device capabilities reported by the terminal. For example, when the user predominantly consumes short-form content on a mobile terminal with intermittent connectivity, the server selects a template for a short documentary script with concise sections and lower bitrate media.

The server constructs a prompt sentence by embedding instruction information into the selected template. The server fills placeholders of the template with phrases representing the user interest targets, with structural requirements describing an introduction and multiple thematic sections, and with expression conditions specifying tone, neutrality, and technical depth. The server stores the constructed prompt sentence in association with a generation request identifier and a user identifier. The server inputs the prompt sentence to a generative AI model. In one embodiment, the generative AI model is implemented as a transformer-based autoregressive language model deployed on a hardware accelerator. The model includes a plurality of decoder layers that apply masked self-attention and feedforward transformations to sequences of tokens. The server tokenizes the prompt sentence into token identifiers and supplies them to the generative AI model. The generative AI model computes, at each decoding step, probability distributions over the vocabulary by applying the learned weight matrices and attention mechanisms, and the server samples or selects output tokens under configured parameters including a temperature parameter and a top probability parameter. The server concatenates the output tokens to obtain generated information in the form of text.

The server edits the generated information using natural language processing techniques. The server segments the generated information into structural units based on headings, punctuation, and template-defined section markers. The server applies a style analysis module to detect biased expressions or non-neutral phrasing according to predefined lexicons and classification models, and replaces such expressions with neutral alternatives. The server also applies a length control module that measures token counts or character counts per section and truncates or expands sections by summarization or controlled re-generation. The summarization uses an encoder-decoder neural network trained with a cross-entropy loss to compress sections while preserving key terms, thereby enforcing a predetermined length and structure.

The server then converts the edited generated information into medium data in a documentary format. The server executes voice generation processing by passing the edited text to a text-to-speech engine. The text-to-speech engine implements a sequence-to-sequence neural network that predicts mel-spectrogram frames from phoneme or character sequences, and a neural vocoder that converts spectrograms into waveform samples. The server controls prosody parameters to align section boundaries with speech pauses, reducing cognitive load on the user and improving intelligibility. The server performs image selection processing or video composition processing by extracting key phrases from each section and retrieving corresponding images or background clips from a media repository using vector similarity search based on the same embedding model. The server arranges images or clips on a time axis synchronized with the narration audio, and composes the sequence into a video stream using a media processing library. The server encodes the video stream into an adaptive streaming format, generating distribution data suitable for playback under varying network conditions.

The server transmits distribution data to the terminal via a communication network. The server assigns a media identifier and generates a manifest file describing available bitrates and segment URLs. The terminal requests the manifest file using a network protocol and selects appropriate segments according to its local communication state information. During playback, the terminal logs playback events, segment-level viewing durations, and user interactions such as volume changes, seeking, and termination events. The terminal transmits viewing history information and evaluation information back to the server as structured data.

The server updates the interest information and configuration conditions of the prompt sentence based on the feedback. The server associates each viewing session with the interest targets embedded in the corresponding prompt sentence and with the structure of the medium data. The server increases the interest level of phrases associated with segments that are viewed with high completion ratios and positive evaluations, and reduces the interest level of phrases associated with segments that are frequently skipped or negatively evaluated. The server updates the user interest vector by recomputing the weighted sum of phrase vectors, thereby shifting the interest representation in the vector space. The server simultaneously adjusts the configuration conditions of future prompt sentences by updating template selection criteria, structural requirements, and expression conditions. For example, if the server detects that the user consistently watches in-depth technical segments to completion, the server increases a technical depth parameter and selects templates with more detailed sections for subsequent prompt sentences.

The server thereby implements a feedback-driven control loop that changes how the generative AI model is invoked and how generated content is post-processed, based on actual usage telemetry from the terminal. This closed-loop adjustment improves the alignment between the generative process and observed user behavior over time. Because the server uses structured interest information, vector representations, and explicit prompt configuration parameters, the system achieves computational benefits such as reduced model invocation frequency, fewer unnecessary long generations, and lower network bandwidth consumption by avoiding repeated generation and distribution of unengaging content.

In one concrete example, the server detects from browsing logs and social communication that the user frequently accesses content related to environmental issues, such as climate change and renewable energy. The server extracts phrases including “climate change,” “carbon emissions,” and “renewable energy” and computes high interest levels for these phrases. The server then constructs a prompt sentence such as:

“Generate a documentary-style script about environmental issues, focusing on climate change, carbon emissions, renewable energy, and plastic pollution. The user already has basic knowledge, so go beyond simple definitions and include recent scientific findings and real-world case studies. The script should be suitable for about 10 minutes of narration and divided into clear sections with headings.”

The server feeds this prompt sentence to the generative AI model, obtains a draft script, edits the script for neutrality and length, and converts the revised script into narrated video. The server encodes the video into distribution data and delivers it to the terminal. If the user watches almost the entire video and provides a positive evaluation, the server increases the interest level of related phrases and selects future templates that include deeper policy analysis and longer segment durations.

In a second concrete example, the server identifies that the user has a growing interest in space exploration based on search queries and viewing of space-related clips on the terminal. The server constructs a prompt sentence such as:

“Based on the user's strong interest in space exploration, generate a documentary script that explains the history of Mars missions, current exploration programs, and future plans for human settlement on Mars. Divide the script into an introduction, three thematic chapters, and a conclusion, and adopt an engaging but technically accurate tone suitable for a user with intermediate knowledge of astronomy.”

The server again applies the generative and post-editing pipeline, but selects a different template that includes more detailed technical descriptions of spacecraft and mission timelines, as the updated interest information indicates tolerance for more complex content.

In another embodiment, the server uses a different neural network architecture for the generative AI model, such as a mixture-of-experts model that routes tokens through different expert subnetworks. The server maintains routing parameters that are adjusted during training using a load-balancing loss function, enabling efficient use of computing resources and further improving generation speed. The server may also employ data augmentation during training by paraphrasing or segment-level reordering of training texts to enhance robustness to prompt formulation variations, thus reducing the sensitivity of output quality to small prompt changes.

The server achieves technical effects that go beyond mere automation of human authoring. By organizing user behavior and communication information into machine-readable interest vectors and by configuring prompt sentences programmatically, the server enables the generative AI model to operate under constraints that reduce unnecessary computation and bandwidth. By applying post-generation structural and stylistic validation, the server prevents degenerate or malformed outputs from being transmitted to the terminal, reducing the need for manual curation. The feedback-driven updates to interest information and prompt conditions improve the precision of future generations, decreasing the number of iterations required to deliver content that is actually consumed, and thereby reducing overall server load and network usage. The vector-space operations and template selection algorithms are not conventional human editorial processes but specific computational procedures designed to exploit neural representations and structured metadata, which improves the performance and efficiency of the underlying computer system.

In yet another embodiment, the server adjusts encoding parameters of the distribution data based on communication state information from the terminal. When the terminal reports persistent low bandwidth, the server selects encoding profiles with lower bitrates and modifies prompt conditions to favor shorter, more focused narratives, thereby reducing data volume per unit of useful information. This interaction between prompt configuration, generation, and encoding constitutes a coordinated control strategy that yields technical benefits in terms of communication load reduction and latency mitigation.

The terminal in these embodiments is not a passive display device, but functions as a source of detailed telemetry that drives updates to the server's internal data structures and models. The terminal produces structured viewing history information with fine time granularity, enabling the server to correlate specific portions of the medium data with engagement signals. This correlation supports more precise adjustment of interest information and prompt sentence configuration conditions than conventional aggregate logging methods, leading to improved personalization accuracy and more efficient use of computational and network resources.

Through these configurations, the server, the terminal, and the user interact in a manner that allows the system to generate and deliver personalized documentary media while improving core computer operations, including data management, processing efficiency, model invocation control, and network resource utilization.

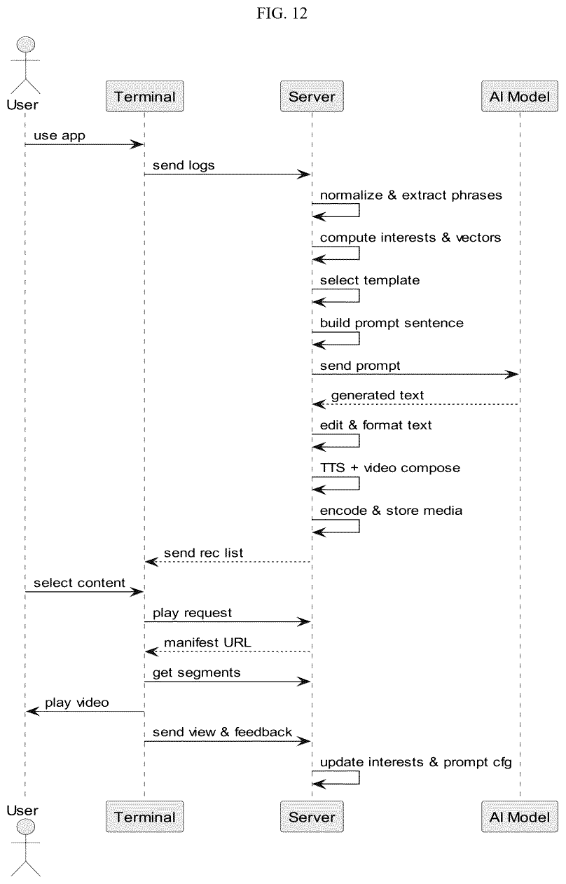

The following describes the processing flow using FIG. 12.

Step 1:

Server acquires raw user data.

Server receives, as input, user behavior information and communication information from the terminal and external communication services. Server receives HTTP requests containing browsing logs, playback logs, search queries, and interaction events from the terminal, and receives posts, comments, and reactions from external services via their application programming interfaces. Server stores, as output, the received data in a log database, with each record including a user identifier, a timestamp, a device identifier, and a text field. Server performs basic validation, such as checking authentication tokens and data formats, and rejects malformed or unauthorized inputs.

Step 2:

Server normalizes text information.

Server reads, as input, the text fields from the log database, including page titles, article snippets, queries, and message bodies. Server executes character string normalization processing by converting all text to a unified encoding, lowering case, removing markup tags, URLs, control characters, and redundant whitespace. Server uses a text processing library to perform this operation in batch mode. Server outputs cleaned text records, and writes them to a normalized-text table that preserves links to the original log entries.

Step 3:

Server performs phrase extraction.

Server takes, as input, the normalized text records. Server applies tokenization and part-of-speech tagging using a natural language processing library to segment each text into tokens and to assign grammatical labels. Server executes phrase extraction processing by identifying noun phrases, domain-specific terms, and multi-word expressions based on the tagging results and dictionary rules. Server computes counts of each extracted phrase per user. Server outputs a phrase list for each user and stores this in a phrase table together with phrase frequencies and references to the source text records.

Step 4:

Server computes interest information.

Server takes, as input, the phrase list and phrase frequencies for each user, along with temporal metadata such as timestamps and dwell times derived from viewing logs. Server calculates an interest level for each phrase by applying a weighted formula that combines occurrence frequency, recency decay, and viewing duration. Server may compute, for example, an interest score equal to frequency multiplied by a time-decay factor and a dwell-time factor. Server outputs interest information that includes, for each user, phrases indicating user interest targets and associated interest levels. Server writes the interest information to an interest profile table.

Step 5:

Server generates vector representations of interests.

Server takes, as input, the phrases from the interest profile table. Server feeds each phrase into a neural network-based encoder, such as a transformer-based embedding model running on a hardware accelerator, to obtain a fixed-dimensional vector. Server uses the encoder's final hidden layer output as the vector representation of the phrase. Server multiplies each phrase vector by its interest level and sums these weighted vectors to form a user interest vector. Server outputs phrase vectors and a single user interest vector per user, storing them in a vector storage structure linked to the interest profile.

Step 6:

Server selects a content template.

Server takes, as input, the user interest vector, phrase vectors, and template metadata stored in a template table. Server computes similarity scores between the user interest vector and template descriptors, which may also be represented as vectors, using a similarity function such as cosine similarity. Server also reads user setting information, including preferred media types and typical viewing durations, and device capability information reported by the terminal. Server combines these factors to select a specific template that defines the type and structure of a document medium or a video medium. Server outputs a selected template identifier and template text that includes placeholders for interest targets, structure, and style.

Step 7:

Server constructs a prompt sentence.

Server takes, as input, the selected template text, the high-interest phrases, and the interest levels. Server fills the template placeholders with concrete values: server inserts main user interest targets into placeholders for topics, inserts related phrases into placeholders for subtopics, and sets structural parameters (such as number of sections and desired duration) based on the template and user viewing patterns. Server also sets expression conditions, such as tone and technical depth, using rules that map interest levels and prior viewing performance to style parameters. Server outputs a concrete prompt sentence as a natural language instruction.

Step 8:

Server sends the prompt sentence to the generative AI model.

Server takes, as input, the constructed prompt sentence and generation parameters such as maximum token count and temperature. Server tokenizes the prompt sentence into model-specific tokens and transmits these tokens and parameters to a generative AI model endpoint running on a hardware accelerator or external computation service. Server receives, as output, token sequences generated by the model. Server decodes the token sequences into text to obtain generated information that includes personalized explanatory information corresponding to the user interest targets. Server writes the generated information to a generation log table along with the original prompt sentence.

Step 9:

Server verifies and edits generated information.

Server takes, as input, the raw generated information from the generative AI model. Server segments the text into structural units, such as sections and paragraphs, based on headings, punctuation, and template rules. Server runs style and neutrality checks using a classification model or rule-based filters to detect biased expressions and off-topic content. Server replaces or removes problematic phrases and rewrites sentences as needed. Server applies summarization algorithms to sections that exceed a target length, computing shorter versions by extracting key sentences or regenerating summaries while preserving key terms. Server outputs validated and edited generated information that conforms to neutrality and length constraints and stores it in a script table.

Step 10:

Server converts text into audio and synchronizes media elements.

Server takes, as input, the edited generated information from the script table. Server passes text segments for each section to a text-to-speech engine, which generates corresponding audio data files. Server associates each text segment with its audio duration and stores this timing information. Server extracts keywords from each section and queries a media repository for images or video clips with metadata matching the keywords, using similarity search over media descriptors. Server outputs a set of audio files, selected images or clips, and timing metadata that prescribe alignment between narration and visual content.

Step 11:

Server composes documentary-format medium data.

Server takes, as input, the audio files, visual media elements, and timing metadata. Server constructs a composition timeline by arranging media objects so that narration audio aligns with relevant images or clips, inserting transitions between sections according to the selected template's structure. Server uses a media processing library to combine the audio and visual tracks into continuous video data, encoding frame sequences and audio waveforms into a container format. Server outputs medium data in a documentary format that includes an introduction, thematic sections, and a conclusion, linked to the user interest targets.

Step 12:

Server prepares distribution data.

Server takes, as input, the documentary-format medium data. Server transcodes the medium data into multiple resolution and bitrate variants suitable for adaptive streaming. Server segments each variant into short media segments, generates a manifest file describing segment URLs and media profiles, and stores the segments on a storage system accessible via the network. Server outputs distribution data in the form of encoded segments and manifest file locations, and registers a media identifier and playback URLs in a media catalog table.

Step 13:

Terminal requests and receives distribution data.

Terminal takes, as input, recommendations or notifications from the server that include media identifiers and playback URLs. Terminal displays titles, descriptions, and thumbnails to the user. User selects a recommended item via a user interface. Terminal sends a playback request including the media identifier to the server. Terminal receives, as output, a manifest URL and, by accessing that URL, retrieves manifest data and segment URLs. Terminal uses local communication state information to request appropriate bitrate segments and buffers them for playback.

Step 14:

Terminal plays back the personalized documentary.

Terminal takes, as input, the media segments retrieved from the server or a content distribution node. Terminal decodes video and audio data using built-in media codecs, renders images on the display, and outputs sound through speakers or headphones. User views and listens to the personalized documentary content. Terminal monitors playback state, including play, pause, seek, and stop events, and measures viewing duration for each segment.

Step 15:

Terminal sends viewing history and evaluation information.

Terminal takes, as input, playback events and explicit user feedback, such as ratings or preference selections. Terminal aggregates this information into viewing history information that includes timestamps, segment identifiers, playback durations, and completion ratios, and into evaluation information that includes rating values or feedback flags. Terminal transmits these data structures to the server via a feedback interface.

Step 16:

Server updates interest information and prompt configuration conditions.

Server takes, as input, the viewing history information and evaluation information from the terminal and the existing interest profile and generation logs. Server correlates each viewed medium item with its associated interest targets and prompt sentence configuration, and calculates engagement metrics, such as average watch percentage and average rating per topic. Server adjusts interest levels by increasing scores for phrases linked to high-engagement segments and decreasing scores for phrases linked to low-engagement segments. Server recomputes the user interest vector from the updated interest levels and updates the interest profile table. Server also adjusts prompt configuration conditions, such as preferred template, section count, and technical depth parameters, based on engagement patterns. Server outputs updated interest information and updated prompt configuration parameters, which will be used as input for subsequent executions of Steps 6 and 7.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content recommendation and media generation systems primarily focus on selecting existing items from a catalog or performing simple text summarization of retrieved documents. Such systems typically (i) rely on fixed templates or static rules for formatting, (ii) treat information collection, summarization, and presentation as separate and weakly coupled stages, and (iii) provide limited personalization of the structure and visual form of the output. As a result, these systems are often unable to transform large volumes of heterogeneous, web-scale document data into coherent, neutrally edited, and visually structured media that is tailored to the user's latent interests and actual viewing behavior.

From a computer technology standpoint, existing architectures do not provide an integrated control mechanism by which a processor dynamically coordinates information acquisition, natural language processing, and generative media layout using a generative AI model under explicit prompt sentence control. In particular, known systems do not (a) generate prompt sentences based jointly on user interest information and structured document data, (b) convert AI-edited textual output into machine-usable media configuration information that explicitly encodes scene information, explanatory text information, and visual element information, and (c) iteratively refine both crawling conditions and prompt sentences based on feedback signals such as viewing history information or user feedback information. Consequently, computing resources are not efficiently allocated to the most relevant sources and sub-themes, and the generative AI model is not effectively steered to produce media-ready outputs that can be rendered with low additional processing overhead on user terminals.

Furthermore, conventional systems lack a processor-level mechanism for automatically classifying AI-edited content into sub-themes according to both importance and topic similarity, and for mapping these sub-themes into a structured media script that can be programmatically transformed into scenes, subtitles, and visual elements. This limitation results in ad-hoc or manual post-processing pipelines, increased latency, and higher computational and operational complexity for generating multimedia content from textual sources.

Accordingly, there is a need for a computer-implemented technique that improves the functioning of a server system by tightly integrating: (i) acquisition and structuring of document information from multiple information sources; (ii) generation and refinement of prompt sentences for a generative AI model based on user interests and collected data; (iii) neutral editing and organization of information by the generative AI model; (iv) automatic generation of media configuration information that encodes scenes, explanatory texts, and visual elements; and (v) adaptive updating of prompt sentences and information collection conditions based on user interaction data. Such a technique should enable a processor to generate, with reduced manual intervention and improved computational efficiency, visually attractive media content that is technically optimized for automated rendering and distribution to user terminals.

The specific processing by the specific processing unit 290 of the data processing device 12 in Example 2 is realized by the following means.

The present invention provides a server comprising a processor configured to acquire, from a terminal, input information or behavior history information related to a user interest target, identify an interest of a user based on the input information or the behavior history information, use information acquisition software to obtain document information corresponding to the identified interest from a plurality of information sources via an information communication network, format the obtained document information as structured data, generate a prompt sentence for a generative AI model based on the identified interest and the structured data, input the prompt sentence and the structured data to the generative AI model to cause the generative AI model to generate edited information including neutrally edited information, generate media configuration information including scene information, explanation text information, and visual element information based on the edited information, automatically generate visually attractive media content by using the media configuration information, distribute the media content to the terminal of the user, and, based on viewing history information or feedback information acquired from the terminal of the user, update at least one of content of the prompt sentence input to the generative AI model and an information collection condition used by the information acquisition software. This enables an improvement in computer functionality by allowing the server to dynamically control information collection and generative processing as an integrated pipeline, to offload complex summarization and layout tasks to the generative AI model under explicit prompt sentence guidance, to automatically transform large-scale, heterogeneous document data into structured, media-ready configuration information, and to adapt subsequent media generation in response to user interaction data, thereby reducing processing overhead, improving relevance and coherence of generated media, and facilitating efficient automated rendering and delivery of personalized media content to user terminals.

The term “processor” refers to a hardware computing element or a combination of hardware computing elements, such as a central processing unit or a graphics processing unit, that executes programmed instructions to perform data acquisition, analysis, and control operations described in the present system.

The term “user” refers to an entity, such as an individual or an organization, that provides interest-related input information or generates behavior history information, receives media content, and interacts with the system via a terminal.

The term “terminal” refers to an information processing device operated by the user, such as a mobile device, a portable computing device, or a stationary computing device, that is configured to transmit user information to the server and to display or reproduce media content received from the server.

The term “input information” refers to information explicitly provided by the user through the terminal, including but not limited to text strings, selection operations, or configuration settings that indicate an interest target or preference.

The term “behavior history information” refers to information implicitly or explicitly recorded by the system regarding user actions, including but not limited to viewing logs, interaction logs, playback operations, and feedback operations associated with media content.

The term “user interest target” refers to a subject, topic, or field that represents an area of interest of the user, identified based on input information or behavior history information.

The term “interest of a user” refers to an interest profile or interest parameter set representing one or more user interest targets inferred or determined by analysis of input information or behavior history information.

The term “information communication network” refers to a communication infrastructure, including at least one of a local network and a wide-area network, that allows the server to access external information sources and to exchange data with the terminal.

The term “information acquisition software” refers to a program or a set of programs executed by the processor that are configured to retrieve document information from multiple information sources via the information communication network, including functionalities such as sending requests, receiving responses, and parsing data.

The term “information source” refers to a data providing entity accessible via the information communication network, such as a server, a storage service, or a database service, that provides document information relevant to the user interest.

The term “document information” refers to digital information obtained from an information source that includes at least textual data representing content such as articles, reports, or descriptive texts related to the user interest.

The term “structured data” refers to document information that has been organized into a defined data format with explicit fields or attributes, such as title, body text, metadata, and topic labels, to facilitate subsequent processing by the processor.

The term “generative AI model” refers to a machine-learned model, such as a large-scale language model or a generative model for text or multimodal content, that is configured to generate new output information in response to input information and a prompt sentence.

The term “prompt sentence” refers to a control instruction expressed in natural language or a structured format, provided as input to the generative AI model to specify a task, a style, a constraint, or a processing objective for generating output information.

The term “edited information” refers to information generated by the generative AI model based on the prompt sentence and the structured data, in which the original document information has been processed by operations such as summarization, rephrasing, reorganization, and classification.

The term “neutrally edited information” refers to edited information in which the generative AI model has removed or reduced subjective expressions, biased wording, or personal opinions, and presented content in an objective and balanced manner.

The term “media configuration information” refers to data that describes a structure of media content in a machine-readable form, including definitions of scenes, explanatory texts, and visual elements, and that serves as a blueprint for automatic generation of media content.

The term “scene information” refers to information within the media configuration information that specifies a unit of media presentation, including at least a sequence order, a duration, and associated textual and visual elements for the unit.

The term “explanation text information” refers to textual content, such as descriptions, narrations, or captions, that is assigned to scenes within the media configuration information to explain or supplement visual elements.

The term “visual element information” refers to data specifying visual components of media content, including at least images, graphic layouts, or visual styles, and their positions or attributes within each scene.

The term “visually attractive media content” refers to output content generated based on the media configuration information that combines explanatory texts and visual elements in a structured and aesthetically appealing manner, suitable for display or reproduction on a terminal.

The term “distribute” refers to the act of transmitting or making available media content or associated access information from the server to the terminal via the information communication network.

The term “viewing history information” refers to behavior history information specifically related to the consumption of media content, including at least viewing time, playback position, content selection, and user interactions such as pause or skip operations.

The term “feedback information” refers to information indicating an evaluation or preference of the user regarding media content, including but not limited to ratings, explicit feedback inputs, or selection of preference options.

The term “information collection condition” refers to a parameter or a set of parameters used by the information acquisition software to control acquisition of document information, including at least selection of information sources, query terms, and update frequency.

The term “configuration of media content” refers to a structural arrangement of elements within media content, including division into scenes, ordering of segments, allocation of explanatory texts, and association of visual elements.

The term “presentation format of media content” refers to a mode in which media content is provided to the user, including at least a type of medium, such as text-based presentation, slide-based presentation, or time-based audiovisual presentation, and associated display or playback characteristics.

In one embodiment, a server includes a processor, a memory, a non-transitory storage medium, and a network interface coupled via a hardware bus. The server executes a program stored in the non-transitory storage medium to perform acquisition of document information, generation and control of prompt sentences for a generative AI model, generation of media configuration information, and distribution of media content to a terminal.

The server operates in cooperation with one or more terminals and a plurality of external information sources connected via an information communication network. The terminal may be implemented as a smartphone, a tablet, or a personal computer, and includes at least a processor, a memory, a display, an audio output unit, and a network interface. The user operates the terminal to provide input information and to consume media content generated by the server.

The server uses general-purpose computing hardware, such as one or more central processing units and optional graphics processing units, to execute software components. The software components include an operating system, a web server module, an information acquisition module, a data structuring module, a generative AI control module, a media configuration generation module, a media rendering and packaging module, and a logging and feedback analysis module. In one concrete implementation, the information acquisition module is realized by a program using a scripting language together with libraries such as an HTTP client library and a web-page parsing library corresponding to, for example, a general-purpose HTML parser. The generative AI control module is realized by a program using a machine learning framework such as a tensor computation library or a deep learning framework.

The server stores document information, structured data, user interest profiles, media configuration information, and generated media content in one or more data stores. The data stores include a relational database management system for tabular data and a document-oriented database or object store for unstructured and semi-structured data. The server defines specific data structures, such as a user interest record including fields for user identifier, interest keywords, and interest weights, and a document record including fields for source identifier, title text, body text, publication time, and topic labels.

The terminal sends user input information to the server. The user inputs an interest target, such as a topic string, through a graphical user interface on the terminal. The terminal transmits the input information over a secure communication protocol to the server. The terminal may also send behavior history information, such as a viewing log or feedback inputs, to the server. The viewing log includes data such as content identifier, playback duration, interaction events, and time stamps. The server analyzes input information and behavior history information to identify an interest of the user. The server applies a feature extraction process to the input information and viewing history, using term frequency statistics, embedding vectors, or categorical features. The server stores these features in an in-memory representation and updates an interest profile for the user using a weighted update rule. For example, the server increases a weight for a topic that appears frequently in the user's input and that is associated with long viewing durations in the viewing history. This interest profile becomes part of the context used to construct prompt sentences for the generative AI model. The server uses information acquisition software to obtain document information from a plurality of information sources. The server constructs query terms by expanding the user interest target with related keywords derived from the interest profile and from embedding similarity between terms in a pre-trained vector space. The server dispatches HTTP requests to multiple source endpoints. The server receives HTML or structured documents and parses them to extract article bodies, titles, and metadata. The server filters non-content elements such as navigation menus or advertisement blocks by applying structural heuristics and content-length thresholds.

The server converts the acquired raw text into structured data. The server applies text normalization, language detection, duplication detection using hash-based or embedding-based similarity, and segmentation into paragraphs or sentences. The server creates a structured representation, for example, an object with attributes including title, cleaned body text, source URL, topic candidate, and a relevance score. The server stores the structured data in the database and also maintains an in-memory batch of such objects for immediate processing.

The server controls a generative AI model by generating and providing a prompt sentence together with the structured data. The generative AI model is implemented as a neural network architecture, such as a transformer-based sequence model, trained on large-scale text corpora. The model includes an embedding layer that converts tokens to vectors, a plurality of attention layers that perform self-attention and feed-forward operations, and an output layer that generates probability distributions over tokens. The server stores model parameters on a GPU memory or main memory, and uses a machine learning framework to perform inference.

The server constructs the prompt sentence in a non-trivial, data-dependent manner. The server first aggregates structured documents into clusters based on embedding similarity. The server computes document embeddings using either an internal embedding model or an embedding function of the generative AI model. The server applies a clustering algorithm, such as k-means or hierarchical clustering, to group documents into sub-themes. The server then selects representative sentences or extracted key phrases from each cluster. The server inserts these elements into a prompt template that specifies the desired task and neutrality constraints. For example, the server uses prompt sentences such as:

“Read the following articles about [TOPIC]. Extract key points, eliminate duplication, and write a neutral, unbiased summary organized by sub-themes. Avoid personal opinions and clearly distinguish facts from speculation.” or

“Transform the following neutral summary about [TOPIC] into a detailed script for a short documentary. Include a section structure, on-screen text, narration sentences, and suggestions for visuals for each segment.”

The server replaces [TOPIC] with the user interest target, such as “space science,” and appends the structured text segments in a defined order. The server therefore generates a prompt sentence that encodes both user-specific interests and document-specific structure. This generation is not a simple template fill, but is based on clustering outputs and importance scores computed from the structured data. The server sends the constructed prompt sentence and associated context text to the generative AI model, and receives edited information as an output sequence.

The server processes the output of the generative AI model to generate edited information in a machine-parsable form. The server applies a parsing module that splits the generated text into sections, headings, bullet points, and narrative segments by recognizing markers, punctuation, and keywords. The server converts the parsed output into a structured internal format, such as a list of sub-theme objects each containing a title, a neutral summary, and associated key facts. The server may apply a secondary check using a rule set to flag subjective expressions or redundant sentences and, if needed, sends an additional prompt sentence to the generative AI model instructing it to revise or refine the text.

The server generates media configuration information from the edited information. The server maps each sub-theme to one or more scenes. The server sets attributes for scenes, including scene order, approximate duration, and a type label such as “introduction,” “explanation,” or “recap.” The server generates explanation text information by selecting or lightly rewriting the neutral summaries as narration or captions. The server generates visual element information by associating each scene with visual descriptors, such as “galaxy background,” “planet surface,” or “timeline chart.” The server may use a separate classifier or keyword extractor to select visual descriptors based on the content.

The server structures the media configuration information in a dedicated schema, such as a scene configuration object including fields for scene identifier, textual content segments, graphic layout type, and visual asset references. This explicit structure allows downstream media rendering modules to operate directly on the configuration without needing to re-interpret or re-parse free-text instructions. As a result, the server reduces processing overhead and eliminates repeated parsing operations at the terminal.

The server uses the media configuration information to generate media content. The server may generate slide-based media by rendering templates that place text and images according to the configuration. The server may also generate time-based media, such as a video file, by synthesizing a sequence of frames with overlaid text and graphics. The server uses multimedia processing libraries to combine background image assets, caption overlays, and audio tracks derived from narration texts. The server may obtain audio by sending the narration texts to a text-to-speech system and then assembling the resulting audio segments according to the scene durations. The server outputs the final media as a set of files or a stream configuration suitable for delivery to the terminal. The server distributes the media content to the terminal. The server stores the generated media in a storage system and records metadata including content identifier, interest topic, creation time, and projection format. The server responds to a request from the terminal by returning media URLs or streaming manifests. The terminal receives these responses, requests media segments as needed, and renders the media using its display and audio hardware.

The terminal decodes the received media and displays or reproduces it according to the media configuration. For slide-based media, the terminal uses a local rendering engine to interpret the scene structure and visual element information and to arrange text and images on the display. For time-based media, the terminal uses a playback module that decodes video and audio streams and synchronizes subtitles or on-screen texts based on embedded timing information. The user views or listens to the content and may provide explicit feedback, such as ratings or preference selections, via the user interface.

The server receives viewing history information and feedback information from the terminal and analyzes them to update both the user interest profile and the information collection conditions. The server computes statistics such as average viewing duration per topic, skip rates for scenes, and engagement indicators for specific visual layouts. The server modifies parameters in the prompt sentence generation process, such as the number of sub-themes, the target length of summaries, or the emphasis on certain source types, based on these statistics. The server also adjusts information collection conditions, such as the weighting of different information sources or the time window for document retrieval.

The server thereby realizes a feedback loop in which the generative AI model is controlled by dynamically adapted prompt sentences that incorporate both prior output and user interaction data. This feedback loop improves computer functionality by enabling the server to prioritize computation on relevant clusters, reduce redundancy in generative processing, and manage data volume more efficiently. For example, by clustering documents and filtering low-importance clusters before constructing the prompt sentence, the server reduces the amount of text passed into the generative AI model, which leads to reduced memory usage and shorter inference times.

The server can employ different configurations of generative AI models. In one embodiment, the server uses a transformer-based language model with attention layers, trained using supervised and unsupervised learning. The model is trained with a loss function such as cross-entropy over token sequences, and model weights are optimized by gradient descent. The server may fine-tune the model using domain-specific corpora and alignment objectives to reduce bias and hallucination rates. During inference, the server sets decoding parameters such as temperature, top-k, and maximum token length to control generation behavior. In an alternative embodiment, the server uses a combination of a base language model for summarization and a smaller model for classification of neutrality and topic labels.

The server can also improve the accuracy of neutrality and relevance by introducing rule-based or auxiliary-model-based checks. The server may compute sentiment scores and subjectivity indicators using a separate classifier to detect whether the generated text contains strong subjective language. If such language is detected, the server issues a revision prompt sentence instructing the generative AI model to remove or rephrase subjective expressions. This hybrid use of model outputs and rule-based checks provides a technical mechanism for reducing bias and improving the reliability of the generated content.

The server improves communication efficiency by limiting transmission of heavy processing artifacts to the terminal. The server performs computationally expensive operations, such as clustering, summarization, and media generation, on the server side. The terminal mainly receives already structured and compressed media. This architecture reduces the computational load and energy consumption at the terminal, which is particularly beneficial for mobile devices, and reduces repeated network requests for raw document data.

The server improves data management by enforcing a unified schema for structured data and media configuration information. The server uses indices over topic labels and user identifiers to quickly retrieve relevant objects and supports cache mechanisms for recently generated media. As a result, the server can respond faster to repeated or similar queries and can reuse previously computed configurations when appropriate, further reducing processing time.

The system is not limited to a particular type of generative AI model or to a particular media format. In another embodiment, the server uses a multimodal generative model that directly outputs layout specifications or lightweight vector graphics instructions. In yet another embodiment, the server generates interactive content such as quiz-like scenes based on the edited information, and the terminal presents such interactive elements to the user. In each case, the use of a structured media configuration information layer between the generative AI model and the rendering subsystem enforces a clear separation of concerns and enables efficient mapping from textual outputs to renderable media objects.

The system provides a technical improvement over conventional approaches in that the server uses specific data structures, clustering-based sub-theming, and prompt sentence control to shape the behavior of the generative AI model in a way that is optimized for subsequent media generation. The server does not simply automate a human editorial workflow, but instead employs non-conventional computational steps—such as embedding-based clustering, schema-driven scene generation, and feedback-based prompt adaptation—that are designed to reduce computation, improve accuracy and neutrality, and enhance the efficiency of end-to-end media generation and delivery.

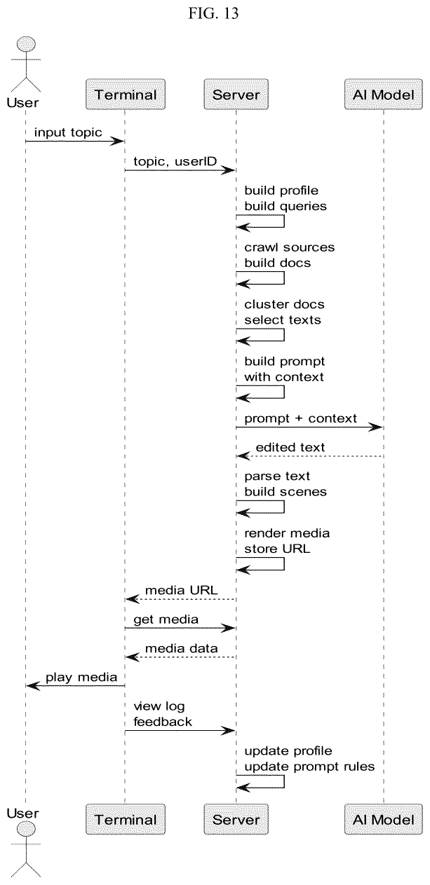

The following describes the processing flow using FIG. 13.

Step 1:

The user operates the terminal to provide interest-related input. The user launches an application or a browser on the terminal and enters an interest target, such as a topic string, into an input field and confirms the input by a selection operation. The input of this step is the textual interest target or configuration information entered on the terminal. The output of this step is a request message including the interest target and optional user identifier, which the terminal sends to the server through a network interface using a communication protocol.

Step 2:

The server receives the request from the terminal and validates the input information. The server parses the request message, checks that the interest target is non-empty, normalizes character encoding, and removes control characters. The input of this step is the request message including the interest target and user identifier. The output of this step is a normalized interest target string and an internal user context object that the server stores in memory for subsequent processing.

Step 3:

The server updates or initializes an interest profile for the user based on the received interest target and any available behavior history information. The server retrieves prior viewing history records for the user from a database, aggregates statistics such as viewing duration per topic, and combines these statistics with the new interest target using a weighted update rule. The input of this step is the normalized interest target string and the behavior history records associated with the user. The output of this step is an updated interest profile containing weighted topic vectors and importance scores, which the server stores as a structured record.

Step 4:

The server generates query terms and information collection conditions for acquiring document information from external information sources. The server applies embedding or keyword expansion to the interest profile to derive related terms, constructs search query strings, and defines parameters such as source priorities and time windows. The input of this step is the updated interest profile. The output of this step is a set of query specifications and information collection conditions that the server passes to the information acquisition software.

Step 5:

The server uses information acquisition software to obtain raw document information from multiple information sources via a network. The server sends network requests using the generated query specifications, receives responses such as HTML pages or structured feeds, and extracts textual content and metadata. The input of this step is the query specifications and information collection conditions produced by the previous step. The output of this step is a collection of raw document items, each including at least a title, a body text segment, a source identifier, and associated metadata.

Step 6:

The server converts the raw document items into structured data suitable for analysis and downstream processing. The server performs operations such as HTML tag removal, language detection, sentence segmentation, duplicate detection via hash comparison or similarity scoring, and relevance scoring based on keyword occurrence and length. The input of this step is the set of raw document items. The output of this step is a structured document set, where each document is represented as a record with defined fields including title, cleaned body text, source URL, timestamp, preliminary topic labels, and a relevance score.

Step 7:

The server groups the structured documents into clusters representing sub-themes related to the user interest. The server computes a vector representation for each document using an embedding function, calculates pairwise distances, and applies a clustering algorithm, such as k-means or hierarchical clustering, to assign documents to clusters. The input of this step is the structured document set. The output of this step is a group of document clusters, each with an identifier, a list of member documents, and derived statistics such as average relevance and central embedding.

Step 8:

The server selects representative content from each document cluster to be used in a prompt sentence. The server orders documents within each cluster by relevance score, extracts key sentences or phrases using heuristic rules or scoring methods such as term frequency—inverse document frequency, and limits the total number of tokens to remain within a predefined context size. The input of this step is the group of document clusters. The output of this step is a set of representative text segments per cluster, annotated with cluster identifiers and importance ranks.

Step 9:

The server constructs a prompt sentence for a generative AI model based on the interest target, the interest profile, and the representative text segments. The server applies a template that specifies the task, such as neutral summarization or script creation, and inserts the user interest target, sub-theme hints, and selected sentences into the template. For example, the server may use a prompt sentence of the form “Read the following articles about [TOPIC]. Extract key points, eliminate duplication, and write a neutral, unbiased summary organized by sub-themes. Avoid personal opinions and clearly distinguish facts from speculation.” The input of this step is the interest target, the interest profile, and the representative text segments. The output of this step is a fully constructed prompt sentence and an ordered context string to be provided to the generative AI model.

Step 10:

The server invokes the generative AI model with the constructed prompt sentence and context to generate edited information. The server encodes the prompt sentence and context into tokens, feeds them into the neural network layers of the model, and computes an output token sequence according to defined decoding parameters. The input of this step is the tokenized prompt and context data. The output of this step is a generated text sequence containing edited information, including at least neutral summaries and organization by sub-themes.

Step 11:

The server parses and structures the generated text sequence into an internal representation of edited information. The server applies a parsing routine that detects section headings, list markers, and delimiter patterns, segments the output into sub-theme units, and extracts associated sentences and key facts. The input of this step is the generated text sequence from the generative AI model. The output of this step is an edited information object composed of multiple sub-theme entries, each entry including a heading, a neutral summary, and a collection of fact statements.

Step 12:

The server performs neutrality and consistency checks on the edited information and, if necessary, requests revisions from the generative AI model using a secondary prompt sentence. The server scans the edited information for subjective terms or unsupported claims using rule-based filters or auxiliary classifiers, and generates a revision prompt sentence such as “Review the following summary and remove any speculative or unverified statements. Ensure all claims are presented as tentative if they are not confirmed facts.” The input of this step is the edited information object. The output of this step is a refined edited information object, in which subjective expressions are reduced and factual clarity is improved.

Step 13:

The server generates media configuration information by mapping sub-themes in the edited information to scenes and assigning textual and visual elements. The server creates a scene structure where each scene is associated with a sub-theme, assigns a position in a sequence, sets an approximate duration, and selects explanation text elements from the neutral summaries. The server also determines visual element descriptors based on keywords and topic labels. The input of this step is the refined edited information object. The output of this step is a media configuration object including scene information, explanation text information, and visual element information.

Step 14:

The server produces a media script or storyboard from the media configuration object. The server organizes scenes into a detailed script format including on-screen text, narration sentences, and suggestions for graphics, following a pattern such as “Transform the following neutral summary about [TOPIC] into a detailed script for a short documentary. Include a section structure, on-screen text, narration sentences, and suggestions for visuals for each segment.” The input of this step is the media configuration object. The output of this step is a structured media script that can be directly consumed by media rendering modules.

Step 15:

The server generates media content based on the media script and media configuration information. The server selects or generates visual assets matching the visual element descriptors, renders layouts that place explanatory texts on backgrounds, and, if applicable, uses a text-to-speech system to generate narration audio from narration sentences. The input of this step is the media script, associated visual descriptors, and narration texts. The output of this step is media content data, such as a set of slide images or a time-based media file including synchronized audio and visual tracks.

Step 16:

The server stores and packages the generated media content for distribution to the terminal. The server writes media files to a storage system, records metadata including content identifier, user identifier, interest target, and generation time, and prepares access information such as URLs or stream manifests. The input of this step is the media content data and associated metadata. The output of this step is a stored media package and a reference record linking the user to the media content.

Step 17:

The server transmits access information or media data itself to the terminal, enabling playback or display. The server responds to a content request from the terminal by providing the media URL, streaming manifest, or embedded media segments. The input of this step is a retrieval request from the terminal that includes a content identifier. The output of this step is a response message that allows the terminal to obtain or stream the media content.

Step 18:

The terminal receives the access information or media data and renders the media content for the user. The terminal requests the specified media segments from the server or storage system, decodes image or video frames, and outputs them on a display, while decoding any audio track and outputting it through an audio unit. The input of this step is the media access information and media streams received from the server. The output of this step is the visual and auditory presentation of the media content to the user.

Step 19:

The user views or listens to the media content on the terminal and may interact with playback controls or provide feedback. The user performs operations such as play, pause, skip, or rating, using the user interface provided by the terminal application. The input of this step is the rendered media content and user interface controls. The output of this step is interaction data and feedback information that the terminal records and prepares for transmission to the server.

Step 20:

The terminal sends viewing history information and feedback information back to the server. The terminal collects data such as total viewing time, scenes viewed, control events, and explicit feedback, packages these data into a log message, and transmits the log message to the server. The input of this step is the locally recorded interaction and viewing data. The output of this step is a behavior history message delivered to the server.

Step 21:

The server analyzes the viewing history information and feedback information to update prompt sentence parameters and information collection conditions. The server aggregates the behavior data, computes metrics such as engagement scores per scene and per topic, and adjusts weights in the user interest profile and parameters used in prompt generation, such as target summary length and number of sub-themes. The server also refines information collection conditions, such as source preferences or time windows, based on observed engagement with previous content. The input of this step is the behavior history message from the terminal. The output of this step is an updated interest profile, updated prompt sentence generation parameters, and updated information collection conditions stored in the server for use in subsequent executions of earlier steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information delivery systems typically retrieve and present content based on static user profiles or simple keyword matching. Such systems do not adequately exploit the full range of machine perception and machine generation capabilities now available. For example, many systems ignore rich behavioral signals (such as detailed browsing histories and interaction logs), and they do not use real-time emotional signals from user devices in a systematic way. As a result, existing systems often produce recommendations that are either irrelevant, redundant, or emotionally inappropriate, and they cannot adapt their generation behavior as the user's state changes over time. Further, although generative AI models have the capacity to synthesize long-form content from heterogeneous sources, typical deployments of these models treat the prompt sentence as a static, manually crafted instruction, and do not algorithmically construct or update prompt sentences using structured user context and feedback logs. Consequently, generative AI models are frequently under-utilized: they either ignore important aspects of the user's long-term behavior and emotional state, or they generate content that is poorly aligned with the user's current cognitive and affective needs. This leads to inefficient use of computational resources, because large amounts of data are processed without producing proportionally improved usefulness for the end user.

In addition, existing systems rarely implement a closed feedback loop that integrates viewing history, interaction events, and evaluation information back into the generation pipeline at the level of prompt sentence design and content structuring. Without such a feedback loop, the system cannot improve its internal representation of user interests or its editing policies over time, and thus cannot refine how it orchestrates retrieval, summarization, bias reduction, and media generation. This limits the capability of computer systems to adaptively control generative AI models as programmable components within an information processing architecture.

Moreover, many systems handle text-level summarization and recommendation but do not provide a technically integrated pipeline that converts neutral, bias-reduced textual outputs into multi-modal information media, such as synchronized visual and auditory content, while dynamically optimizing content structure and emotional tone based on an automatically inferred emotional state. As a result, the overall computer implementation—spanning data collection, model prompting, model invocation, and media composition—remains fragmented, and system-level performance, such as relevance, user engagement, and robustness to bias, is suboptimal.

Accordingly, there is a need for an improved computer-implemented system that (i) programmatically analyzes behavioral information and input information to infer user interests, (ii) acquires and analyzes emotional information to derive an emotional state, (iii) automatically constructs and updates prompt sentences for a generative AI model using these contextual signals, (iv) performs neutral editing through natural language processing, and (v) generates and optimizes multi-modal information media while closing the loop with viewing history and evaluation data. Such a system should improve how the processor orchestrates retrieval, generation, and presentation operations, thereby improving the functioning of the computer itself in the context of personalized, emotion-adaptive information delivery.

The specific processing by the specific processing unit 290 of the data processing device 12 in Application Example 2 is realized by the following means.

The present invention provides a server comprising a processor and a communication interface, the processor being configured to analyze behavioral information and input information of a user to extract an interest subject of the user; to acquire emotional information of the user from a user terminal via the communication interface and identify an emotional state of the user based on the emotional information; to acquire related information from an information resource in accordance with the interest subject and the emotional state; to generate a prompt sentence including an editing policy corresponding to the interest subject and the emotional state, and to input the prompt sentence to a generative AI model so as to cause the generative AI model to generate editing information; to generate neutral edited information by performing, on the basis of the editing information and the related information, natural language processing including at least summarizing, organizing according to importance, and reducing bias; to automatically generate an information medium including at least one of visual information and auditory information on the basis of the neutral edited information; to optimize contents or an expression mode of the information medium in accordance with the emotional state; to distribute the optimized information medium to the user terminal via a network using the communication interface and cause the user terminal to present the optimized information medium; and to update the interest subject and the editing policy based on at least one of a viewing history, an operation history, and evaluation information relating to the information medium and to personalize, on a continuous basis, the prompt sentence and the information medium to be generated thereafter. This enables the computer system to dynamically control a generative AI model and associated media generation pipeline based on structured user behavior and real-time emotional context, thereby improving the technical functioning of the system by increasing relevance and neutrality of generated content, reducing computational waste from poorly targeted generation, and providing an adaptive closed feedback loop that continuously refines model prompting, content editing, and multi-modal presentation.

The term “processor” refers to a hardware-implemented data processing unit, such as a central processing unit or another execution circuitry, that executes instructions to perform analysis, generation, control, and communication operations in the system.

The term “communication interface” refers to a hardware and software interface that enables the processor to send and receive data over a communication network, and that supports bidirectional data exchange with external devices including user terminals and information resources.

The term “behavioral information” refers to data representing actions performed by a user in relation to one or more computing devices or services, including at least browsing histories, search queries, application usage logs, and interaction events.

The term “input information” refers to data that is explicitly provided by a user to the system, including at least text inputs, selections of topics or categories, configuration parameters, and other user-supplied control information.

The term “interest subject” refers to one or more topics, themes, or fields inferred or determined from the behavioral information and the input information as being of interest to the user.

The term “emotional information” refers to data from which an emotional condition of the user can be inferred, including at least image data, sound data, textual data, physiological measurements, or other sensor outputs.

The term “emotional state” refers to a classification or representation of a psychological condition of the user, such as joy, sadness, stress, relaxation, or neutrality, identified on the basis of the emotional information.

The term “information resource” refers to any data source accessible to the server, including at least network-accessible document repositories, databases, content servers, and other storage systems that provide document information or media information.

The term “related information” refers to information acquired from an information resource in association with the interest subject and optionally the emotional state, including at least documents, articles, records, or other content items.

The term “prompt sentence” refers to a text instruction or set of instructions, generated by the processor, that specifies a task, constraints, or an editing policy for a generative AI model, and that guides the behavior of the generative AI model.

The term “editing policy” refers to a set of rules or guidelines, represented explicitly or implicitly in the prompt sentence, that define how the generative AI model is to treat the related information, including at least tone, neutrality level, emphasis, and structural requirements.

The term “generative AI model” refers to a machine-implemented model for information generation that accepts the prompt sentence and optionally source information as input and outputs generated text or other data by performing learned statistical or neural computations.

The term “editing information” refers to data generated by the generative AI model in response to the prompt sentence, including at least draft text, structured outlines, or other intermediate content used as a basis for subsequent editing.

The term “neutral edited information” refers to information that has been produced by performing natural language processing on the editing information and the related information, such that the information is summarized, organized according to importance, and subject to bias reduction to approximate a neutral standpoint.

The term “natural language processing” refers to computational processing of human language data, including at least tokenization, parsing, semantic analysis, summarization, classification, bias detection, and rephrasing.

The term “information medium” refers to a composite content item generated by the processor based on the neutral edited information, including at least one of visual information, auditory information, or a combination of such information in a structured format.

The term “visual information” refers to image-based or video-based data, including at least still images, motion pictures, graphics, text overlays, and visual animations.

The term “auditory information” refers to sound-based data, including at least speech, narration, music, and sound effects.

The term “expression mode” refers to a manner in which content is presented in the information medium, including at least narrative style, pacing, modality composition, layout, and emphasis of elements.

The term “optimize” refers to adjusting one or more parameters of the contents or the expression mode of the information medium in accordance with the emotional state so as to increase suitability or effectiveness for the user.

The term “user terminal” refers to an electronic device operated by the user and communicatively coupled to the server, including at least a portable information device, a stationary computing device, or a display device capable of presenting the information medium.

The term “network” refers to a wired or wireless communication infrastructure that enables data transmission between the server, the user terminal, and the information resource.

The term “viewing history” refers to data indicating which information media or portions thereof have been presented to the user, including at least identifiers, timestamps, durations, and completion states.

The term “operation history” refers to data indicating user interactions with the information medium or with a user interface, including at least play, pause, seek, skip, replay, and other control operations.

The term “evaluation information” refers to data representing an assessment by the user of the information medium, including at least ratings, textual comments, reactions, or other feedback indicators.

The term “personalize on a continuous basis” refers to repeatedly updating at least the interest subject, the editing policy, the prompt sentence, and the generated information medium over time using newly obtained viewing history, operation history, and evaluation information.

In one embodiment, a server cooperates with at least one user terminal to implement the claimed system. The server includes a processor, a memory storing executable instructions and data structures, and a communication interface connected to a communication network. The user terminal includes a processor, a memory, a display, an input device, a camera, a microphone, and a network interface. The server and the terminal execute respective software modules that implement interest extraction, emotion analysis, generative AI model control using a prompt sentence, natural language processing, media generation, optimization, and delivery.

Server stores in the memory a plurality of data structures, for example: (i) a user profile table including a user identifier, a set of interest subjects represented as weighted topic vectors, and preference parameters; (ii) an emotion state table including, for each user identifier, a current emotional state label and confidence scores; (iii) a content index including references to document information and media assets retrieved from information resources; and (iv) a prompt policy table including templates of prompt sentences and associated editing policies.

Terminal operates as a sensing and presentation device. Terminal acquires behavioral information, such as browsing histories, search queries, and interaction logs, from operating system interfaces and application logs. Terminal stores behavioral information in a structured format, for example as records including a timestamp, a resource identifier, a title string, and a category label. Terminal sends such records to the server through the communication interface using a defined network protocol.

Terminal additionally acquires emotional information. Terminal captures image data of a user's face through the camera and sound data of the user's voice through the microphone. Terminal preprocesses the image data by down-scaling and normalizing pixel values, and detects facial landmarks and expression features using a computer vision algorithm such as a convolutional neural network (CNN) trained for facial expression recognition. Terminal preprocesses the sound data by computing acoustic features such as Mel-frequency cepstral coefficients (MFCCs), fundamental frequency, and energy. Terminal generates an emotion feature vector and transmits this vector to the server together with a user identifier.

Server receives the behavioral information and emotion feature vectors and stores them in the memory. Server analyzes behavioral information using a natural language processing pipeline. For example, server uses a tokenizer, a part-of-speech tagger, and a named entity recognizer to extract terms from titles and page contents. Server computes term frequencies and inverse document frequencies to obtain a weighted representation of topics (topic vector). Server determines an interest subject as a set of high-weight topics and stores them in the user profile table. This determination is performed automatically by the processor using statistical methods, and does not merely replicate manual human classification.

Server estimates an emotional state from the received emotion feature vector. In one embodiment, server uses a neural network classifier implemented as a feedforward network that takes as input the concatenated facial and acoustic feature vector. The classifier includes multiple fully connected layers with nonlinear activation functions. The server trains this classifier offline using supervised learning, where labeled emotional states (e.g., joy, sadness, stress, relaxation) are used as targets. Server updates network weights during training by minimizing a cross-entropy loss function with backpropagation and a gradient-based optimizer. After deployment, server uses the trained weights and does not retrain in the field, though the same architecture supports periodic updates.

Server maps the classifier output to a discrete emotional state label with a confidence score and stores it in the emotion state table. Because the emotional state is computed using low-level sensor features and learned network parameters, the system derives a representation that cannot be readily obtained by a human observer at similar speed and scale, thereby improving the technical performance of adaptation.

Server uses both the interest subject and the emotional state to control acquisition of related information from information resources. Server uses the topic vector as a query against external document repositories through search application programming interfaces or by web crawling. Server uses software components analogous to HTTP client libraries and parsing libraries to fetch and parse document information from network resources. Server converts HTML documents into plain text, normalizes encoding, and removes boilerplate content. Server stores the resulting document information in the content index, together with topic tags and metadata such as publication time. This indexing in the server's memory allows subsequent retrieval operations to be performed efficiently with reduced network traffic, because repeated external requests are avoided.

Server then prepares an input for a generative AI model. In one embodiment, the generative AI model is a transformer-based neural network trained to perform conditional text generation. The model includes multiple self-attention layers, feedforward sub-layers, positional encodings, and a large set of learned parameters. The model has been pre-trained on large-scale text corpora and optionally fine-tuned on domain-specific data. The server does not train this model during normal operation, but server controls the model's behavior by constructing a prompt sentence and by selecting source excerpts.

Server selects a subset of document information that is relevant to the interest subject and sorts the documents by relevance and recency. Server extracts passages from these documents, for example the first paragraph, key headings, and conclusion segments. Server uses summarization and scoring algorithms to identify sentences with high information content, such as sentences containing named entities or numerical data. Server concatenates such excerpts into a context text, while ensuring that a maximum token length for the generative AI model is not exceeded.

Server constructs a prompt sentence in accordance with a stored prompt policy template and the current emotional state. For example, when the interest subject is environmental protection and the emotional state is stress, server may generate a prompt sentence such as:

“You are a neutral documentary writer. Based on the following source materials about environmental protection, generate a clear, unbiased script for a 10-minute documentary. Emphasize both current challenges and successful initiatives. The user is currently feeling stressed, so keep the tone calm, encouraging, and not alarming. At the end, add a short, hopeful outlook.”

In another example, when the interest subject is space science and the user has indicated high technical expertise, server may generate a prompt sentence such as:

“Summarize the latest space science research into a 7-minute documentary script that explains advanced propulsion concepts for a technically knowledgeable audience, without over sensationalizing risks.”

Server concatenates the prompt sentence and the context text into a single input sequence according to an instruction format required by the generative AI model. Server sends this input to the generative AI model through a model interface. This interface can be a local model runtime or a remote model service accessible via the communication interface. Server may specify additional generation parameters such as a temperature parameter controlling randomness, a maximum output length, and a sampling strategy (for example, top-k or nucleus sampling). These parameters are selected based on stored policies, allowing the server to systematically control diversity and determinism.

Generative AI model processes the input sequence by embedding tokens, applying multiple layers of attention and nonlinear transformations, and predicting output tokens autoregressively. Inside each attention layer, the model computes query, key, and value projections of token embeddings, calculates attention weights as scaled dot-products, and aggregates values weighted by attention weights. The multi-head structure enables the model to capture different types of dependencies among tokens. By using a transformer architecture with large capacity and learned parameters, the model can integrate constraints encoded in the prompt sentence and factual content encoded in the context text. This internal operation differs from human reasoning, as the model applies complex linear algebra computations at scale that a human cannot replicate manually in similar time.

Server receives generated text from the generative AI model. Server interprets this generated text as editing information that may include a structured script, scene headings, and narrative lines. Server post-processes the editing information using natural language processing. For example, server segments the text into sections, identifies key statements, and applies a bias detection algorithm that checks for polarity, unbalanced wording, or unsupported claims. Server may apply rule-based transformations, such as replacing extreme adjectives with neutral terms or inserting clarifying phrases where needed.

Server then generates neutral edited information. In one embodiment, server applies an extractive-abstractive summarization pipeline: first, server uses sentence scoring to extract representative sentences; second, server condenses or rewrites these sentences using a smaller generative model constrained to maintain factual consistency. Server also organizes content according to importance and chronology, by sorting sections based on importance scores and timestamps from the document information. This multi-stage editing pipeline reduces noise and bias and produces a well-structured text, thereby improving the technical quality of information and reducing cognitive load when later rendered as media.

Server converts the neutral edited information into an information medium. Server maps script sections to a structured data representation of scenes, where each scene has fields such as a textual description, an estimated duration, an associated topic tag, and textual narration. Server retrieves or generates visual information corresponding to each scene. For example, server searches a media asset repository using the topic tag as a query and selects images or video clips with matching metadata. Server may also run a computer vision classifier to label candidate images and ensure semantic alignment with the script.

Server generates auditory information for the narration. Server uses a text-to-speech engine to synthesize speech audio from the text of each scene's narration. The text-to-speech engine may use a neural vocoder and a sequence-to-sequence acoustic model that are configured to produce natural-sounding speech. Server stores the generated speech as digital audio files and aligns their durations with the planned scene lengths.

Server composes the final media using a media processing tool on the server, such as a generic multimedia processing engine. Server configures a timeline where audio tracks and video tracks are arranged with timestamps. Server overlays subtitles derived from the narration onto the video stream. Server may insert transition effects between scenes, adjust audio levels to avoid clipping, and standardize frame rate and resolution. Server controls this tool by issuing commands or by using an application programming interface, and the tool performs frame-level and sample-level processing to produce a compressed media file such as a video file in a standardized format.

Server optimizes the contents or the expression mode of the information medium in accordance with the emotional state. For example, if the emotional state is stress, server reduces the density of alarming statistics, increases the proportion of scenes showing positive developments, and selects a slower background music track. If the emotional state is joy, server may include more dynamic visuals and highlight exciting discoveries. Server accomplishes such modifications by re-evaluating scene importance scores, adjusting scene durations, and selecting alternative visual or audio assets from the repository. These adjustments are performed systematically based on stored rules that map emotional states to parameters such as maximum allowed negative sentiment per minute or target ratio of positive to neutral scenes. This mapping constitutes a set of non-conventional rules that are difficult for a human operator to apply consistently and quickly, and thus provide a technical improvement in automatic media tailoring.

Server distributes the optimized information medium to the user terminal via the communication interface. Server registers the media file and its metadata in a database and generates a network address or streaming endpoint. Server sends a notification to the terminal containing at least an identifier, a title, and a link. Server may use a push notification service or a direct network connection. By keeping the generated media on the server and sending only optimized streams, the system reduces repeated computation and network overhead when multiple terminals are involved. Terminal receives the optimized information medium and displays it. Terminal requests the media file from the server and plays it back using a local media player configured to decode the video and audio streams. Terminal may display on-screen controls for pause, seek, or feedback. Terminal collects viewing history (for example, which scenes were watched, how long the video was played), operation history (for example, where the user skipped or rewatched), and evaluation information (for example, explicit ratings or comments). Terminal sends this data back to the server in a structured format.

Server updates the interest subject and the editing policy based on the feedback data. Server processes viewing history, operation history, and evaluation information to compute updated weights for topics and to adjust policy parameters (for example, preferred length, preferred technical depth, tolerance for negative content). Server may use clustering or reinforcement-learning-style updates to associate certain prompt patterns with higher user satisfaction metrics. For example, server can adjust a parameter in the prompt policy table indicating whether future prompt sentences should explicitly request more examples, more data, or simpler language. This feedback loop allows the server to adapt not only the content but also the design of prompt sentences, thereby improving the effectiveness and efficiency of generative AI model usage over time.

Because the server maintains indexed document information, pre-computed user profiles, and reusable prompt policy structures, the system can generate new information media more quickly when a similar interest subject recurs. The server reuses portions of previous context texts, caches partial summaries, and reuses emotion mappings, which reduces processing time and network load relative to an approach that recomputes all steps from scratch. The data structures and algorithms described above improve system-level performance: the server minimizes redundant web requests, uses efficient in-memory indices, and leverages precomputed features to accelerate content retrieval and generation.

In some embodiments, server deploys multiple generative AI models with different sizes or specialties. For example, a large model may be used for initial script generation, and a smaller, faster model may be used for local rewriting or bias correction. Server selects which model to use based on current load and user requirements, and this scheduling reduces latency and computational cost. Server can also restrict the use of high-capacity models to sections where they provide the greatest marginal benefit in content quality. This technical management of generative AI resources contributes to efficient use of computation and reduced energy consumption.

In another embodiment, server executes a training pipeline to refine an auxiliary model used for summarization or emotion mapping. Server logs generated scripts and user feedback, constructs training examples pairing input context and target edits, and retrains the auxiliary model using gradient-based optimization. Server defines an error function that may include a term for semantic similarity to reference summaries and a penalty term for excessive sentiment polarity. By minimizing this error function, server improves the model's ability to produce neutral edited information. This offline improvement translates into better real-time performance of the deployed system.

Because the generative AI model and associated modules operate on structured inputs (prompt sentences, context texts, feature vectors) and structured outputs (scripts, scene graphs, metadata), the system implements specific data flows and transformations that go beyond generic “data collection, analysis, and display.” Each module operates on well-defined data fields and uses predefined algorithms or learned parameters, and the modules communicate through explicit interfaces. This modular configuration allows for verification, optimization, and partial replacement without conceptual ambiguity.

The described embodiments are not limited to a particular hardware platform or specific software products. Server may be implemented as a physical server, a virtual machine, or a cloud computing instance. Terminal may be implemented as a smartphone, a tablet, a personal computer, or another information processing device. Software modules such as the natural language processing pipeline, the emotion classifier, the generative AI model interface, and the media composer may be realized using various programming languages and frameworks. Nonetheless, in each embodiment, the correlation of behavioral information, emotional information, prompt sentence construction, generative AI model invocation, neutral editing, and multi-modal media generation in the specific sequence and with the specific data structures described herein enables improved technical functioning of the computer system as a whole.

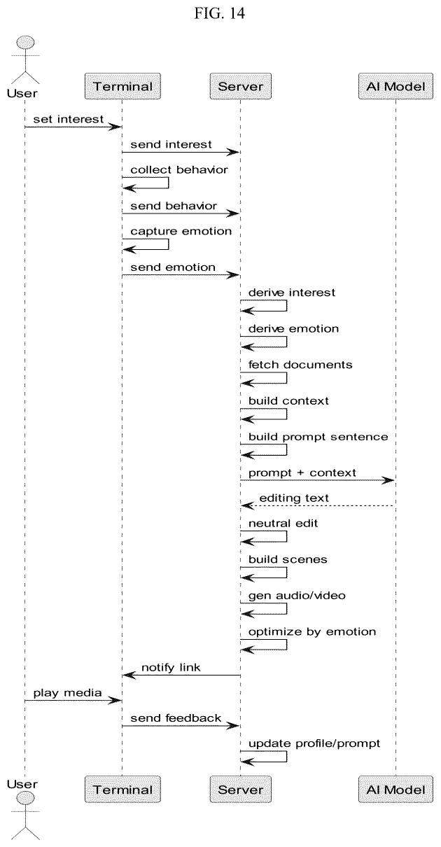

The following describes the processing flow using FIG. 14.

Step 1:

User operates the terminal to provide explicit interest input.

Input: User's manual operations (topic selection, text input, configuration of preferences).

Terminal displays a graphical user interface that includes text fields and selectable topic categories. User enters interest topics (for example, “environmental protection” or “space science”) and presses a confirmation button.

Terminal converts the user input into a structured record including a user identifier, a list of interest keywords, preferred media length, and preferred technical level.

Terminal sends this record as a request message to the server via a network.

Output: Structured interest input data transmitted from the terminal to the server.

Step 2:

Terminal collects behavioral information of the user.

Input: Local logs such as browsing history, search queries, and application interaction events stored on the terminal.

Terminal reads history entries through operating system application programming interfaces and application-specific logs, and extracts fields such as timestamp, visited uniform resource locator, page title, and interaction type.

Terminal performs basic preprocessing such as removing entries older than a predetermined time window and normalizing character encoding.

Terminal aggregates the preprocessed entries into a behavior dataset associated with the user identifier.

Terminal transmits this behavior dataset to the server via the network.

Output: Aggregated behavioral information dataset delivered to the server.

Step 3:

Terminal captures emotional information from the user.

Input: Real-time sensor data from the terminal's camera and microphone while the user interacts with the application.

Terminal records a short sequence of images of the user's face and a short segment of the user's voice.

Terminal performs feature extraction on the images by detecting facial landmarks and computing expression metrics (for example, eyebrow angles, mouth curvature) using a pre-installed computer vision module.

Terminal computes acoustic features from the voice signal, including Mel-frequency cepstral coefficients, pitch, and energy.

Terminal concatenates visual and acoustic features into an emotion feature vector associated with the user identifier.

Terminal sends the emotion feature vector to the server over the network.

Output: Emotion feature vector representing the user's current emotional cues transmitted to the server.

Step 4:

Server determines an interest subject from behavioral information and explicit input.

Input: Structured interest input data from Step 1 and behavioral information dataset from Step 2.

Server stores the received data in memory and parses the behavioral information to extract text fields such as page titles and search queries.

Server applies tokenization, stop-word removal, and part-of-speech tagging to the text fields, and constructs a term frequency—inverse document frequency vector for each entry.

Server aggregates these vectors over all entries for the user and combines them with the explicit interest keywords by increasing the weights of explicitly indicated topics.

Server normalizes the aggregated vector and selects the highest-weight terms as the interest subject, represented as a topic vector.

Output: Interest subject data including a weighted topic vector stored in a user profile table.

Step 5:

Server identifies an emotional state from emotional information.

Input: Emotion feature vector from Step 3.

Server feeds the emotion feature vector into a trained classifier implemented as a neural network model stored in memory.

Server computes layer activations by multiplying the feature vector by learned weight matrices and applying nonlinear activation functions, and obtains class probabilities for candidate emotional states.

Server selects the emotional state label with the highest probability and records both the label and the probability as the emotional state for the user.

Server stores this emotional state in an emotion state table associated with the user identifier.

Output: Emotional state label and confidence value registered for the user.

Step 6:

Server acquires related information from information resources according to the interest subject and emotional state.

Input: Interest subject topic vector from Step 4 and emotional state from Step 5.

Server generates one or more query strings from high-weight topics (for example, “renewable energy”, “climate policy”) and sends requests to external information resources such as document repositories or web servers.

Server receives document information including titles, bodies, timestamps, and source identifiers, and parses markup structures to extract plain text content.

Server calculates a relevance score for each document using similarity between the document's term vector and the interest subject topic vector.

Server filters out low-relevance documents and retains a subset of related information, then indexes the retained documents in a content index with associated metadata.

Output: Set of indexed related documents and associated metadata stored in the content index.

Step 7:

Server prepares context text and constructs a prompt sentence for a generative AI model.

Input: Indexed related documents from Step 6, interest subject from Step 4, and emotional state from Step 5.

Server selects a subset of documents with the highest relevance scores and most recent timestamps, and extracts key passages such as introductory paragraphs and conclusions.

Server computes sentence importance scores using term density and presence of numerical data, and selects top-ranked sentences to form a condensed context text within a predefined token limit.

Server consults a prompt policy table that maps combinations of interest subjects and emotional states to prompt templates specifying tone, length, and structural requirements.

Server fills variable fields in a selected template with the current interest subject and emotional state, thereby generating a prompt sentence such as:

“You are a neutral documentary writer. Based on the following source materials about environmental protection, generate a clear, unbiased script for a 10-minute documentary. Emphasize both current challenges and successful initiatives. The user is currently feeling stressed, so keep the tone calm, encouraging, and not alarming. At the end, add a short, hopeful outlook.”

Server concatenates the prompt sentence and the context text into a single input sequence for the generative AI model.

Output: Combined text input comprising the prompt sentence and context text ready for submission to the generative AI model.

Step 8:

Server invokes the generative AI model to generate editing information.

Input: Combined text input from Step 7 and model control parameters (for example, maximum length, temperature, sampling strategy).

Server sends the combined text input and the control parameters to a generative AI model interface, which applies tokenization and mapping to internal token identifiers.

Generative AI model processes the token sequence using a multi-layer transformer architecture, computing attention scores and generating output tokens autoregressively until a termination condition is met.

Server receives the generated token sequence from the model interface and decodes it into text, which constitutes editing information including a draft script, section headings, and narrative content.

Server checks the generated editing information for completeness and structural markers (for example, chapter separators), and stores the editing information for further processing.

Output: Editing information text produced by the generative AI model and stored in server memory.

Step 9:

Server performs neutral editing of information using natural language processing.

Input: Editing information from Step 8 and related document information from Step 6.

Server segments the editing information into sentences and paragraphs, and aligns generated content with original document sentences by semantic similarity measures.

Server applies a summarization module that scores sentences and selects a subset representing core facts, and applies an abstractive rewriting module to shorten or clarify selected sentences while preserving factual content.

Server runs a bias detection routine that analyzes polarity and subjectivity indicators across the text and identifies highly emotional or unbalanced phrases.

Server replaces identified phrases with neutral equivalents according to a rule set or a smaller constrained generative model, and reorders sections based on importance and chronology determined from metadata.

Server outputs neutral edited information as a revised script that is summarized, organized, and bias-reduced.

Output: Neutral edited information text structured as a finalized script.

Step 10:

Server converts neutral edited information into a structured scene representation.

Input: Neutral edited information script from Step 9.

Server parses the script to identify scene boundaries using explicit headings or cue phrases, and assigns sequence numbers and estimated durations to scenes based on word counts.

Server associates each scene with one or more topic tags by matching keywords and entities in the scene text to a topic vocabulary.

Server constructs a scene data structure for each scene that includes fields for scene identifier, narration text, topic tags, duration, and desired visual category.

Server stores the collection of scene data structures as a scene list in memory.

Output: Scene list data structure representing the information medium plan.

Step 11:

Server generates auditory information for scene narration.

Input: Scene list from Step 10.

Server iterates over scenes and extracts narration text from each scene data structure.

Server submits the narration text to a text-to-speech engine, which converts the text into speech audio by applying an acoustic model and a vocoder.

Server receives raw audio streams from the text-to-speech engine, normalizes audio levels, and encodes the audio into digital audio files stored with scene identifiers.

Server registers audio file locations in the corresponding scene data structures.

Output: Set of narration audio files linked to scenes.

Step 12:

Server selects or generates visual information for scenes.

Input: Scene list from Step 10 and content index from Step 6.

Server queries a media asset repository using topic tags and desired visual categories from each scene to find candidate images or video clips.

Server evaluates candidate assets by comparing metadata and, if available, by running image classification to confirm semantic correspondence with the scene topic.

Server selects one or more assets per scene according to predefined rules, such as preferring recent or high-resolution media.

Server records the selected visual asset identifiers and their file locations in the scene data structures.

Output: Scene list updated with visual asset references.

Step 13:

Server composes an information medium and optimizes its expression mode according to the emotional state.

Input: Scene list with narration audio and visual assets from Steps 11 and 12, and emotional state from Step 5.

Server constructs a timeline specification in which each scene is assigned start and end times, visual assets, narration audio, and subtitle text derived from narration.

Server adjusts scene ordering, durations, and transitions by applying optimization rules that depend on the emotional state, such as increasing time allocated to positive content when the emotional state is stress.

Server selects background music tracks and volume levels to match the emotional adjustment rules, and updates the timeline specification accordingly.

Server invokes a media composition engine to render the timeline into a continuous media file, performing video and audio encoding, overlaying subtitles, and inserting transitions.

Output: Optimized information medium file, for example a video file, stored on the server.

Step 14:

Server distributes the optimized information medium to the user terminal and records presentation metadata.

Input: Optimized information medium file from Step 13 and user identifier from Step 1.

Server generates a uniform resource locator or streaming endpoint for the information medium and stores this link in association with the user and the generation job.

Server sends a notification message to the terminal containing the title, a brief description, a thumbnail reference, and the link to the information medium.

Server logs the distribution event in a viewing history table with timestamps and identifiers to enable subsequent analysis.

Output: Notification containing a link to the information medium delivered to the terminal and distribution event recorded on the server.

Step 15:

Terminal presents the information medium and sends feedback data to the server.

Input: Notification and link from Step 14.

Terminal receives the notification, displays it in a notification area, and, upon user selection, requests the information medium from the server using the link.

Terminal streams or downloads the media file and plays it using a media player, rendering visual and auditory information on the display and speakers.

Terminal monitors user interactions such as play, pause, seek, and stop, and records time stamps and positions for these operations.

Terminal optionally collects explicit evaluation information such as ratings or comments entered by the user.

Terminal assembles viewing history, operation history, and evaluation information into a structured feedback record and transmits this record to the server.

Output: Feedback record describing the user's consumption and evaluation of the information medium delivered to the server.

Step 16:

Server updates user profiles and prompt policies based on feedback.

Input: Feedback record from Step 15, existing interest subject and editing policy data from previous steps.

Server analyzes the feedback record to compute measures such as completion rate, average watch time per scene, frequency of skipping certain topics, and correlation between evaluation scores and content characteristics.

Server adjusts topic weights in the interest subject vector by increasing weights for topics associated with high engagement and decreasing weights for topics consistently skipped.

Server modifies parameters in the prompt policy table, such as preferred media duration, requested detail level, and tolerance for negative sentiment, based on observed feedback patterns.

Server stores updated interest subjects and editing policies in the user profile table, thereby influencing prompt sentence construction and media generation for subsequent executions.

Output: Updated user profile and prompt policy data stored on the server for future personalized generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

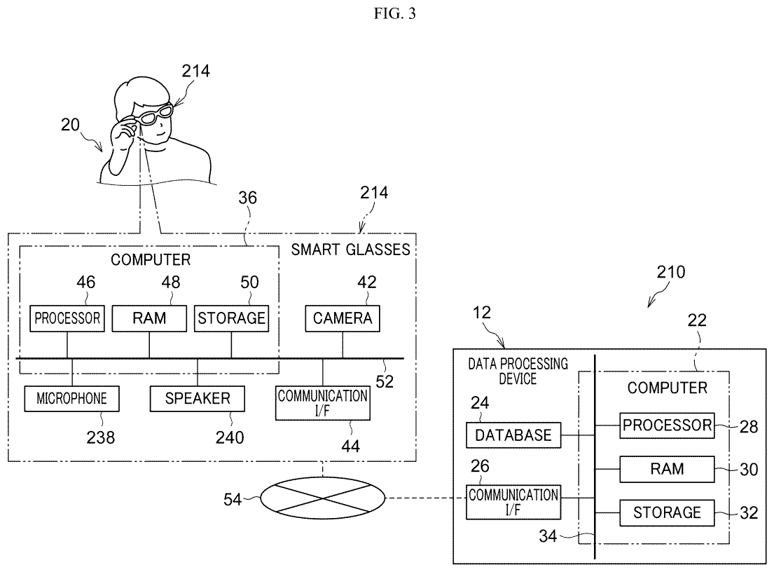

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

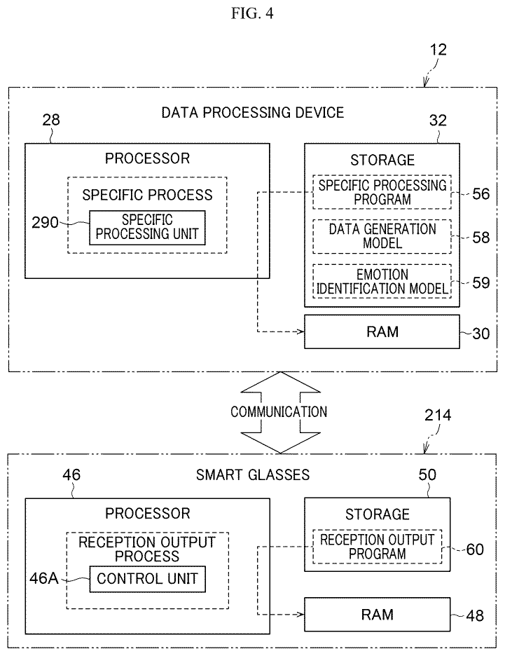

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

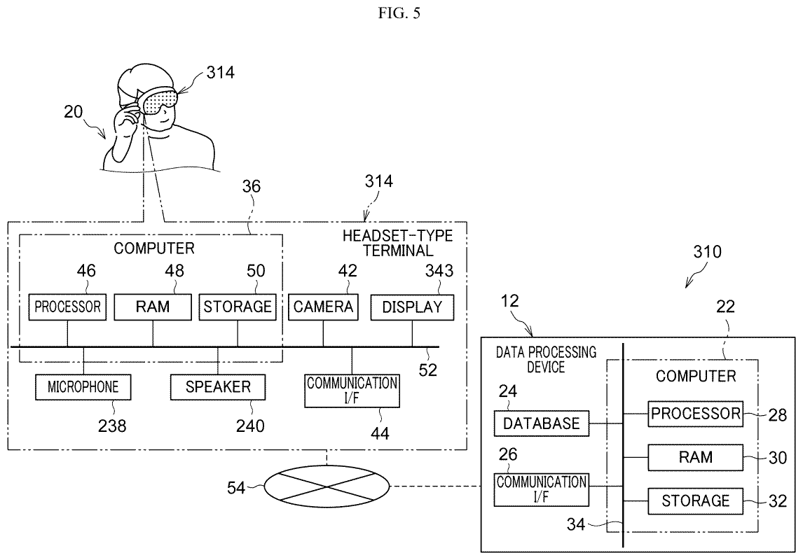

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

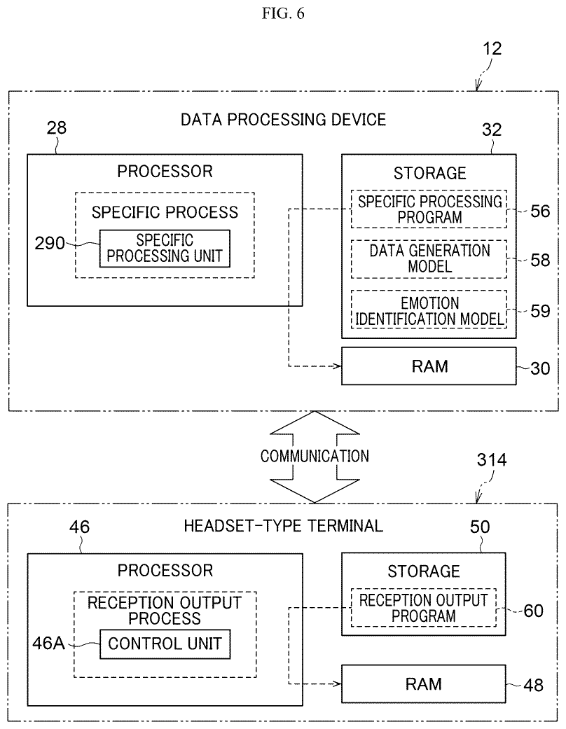

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

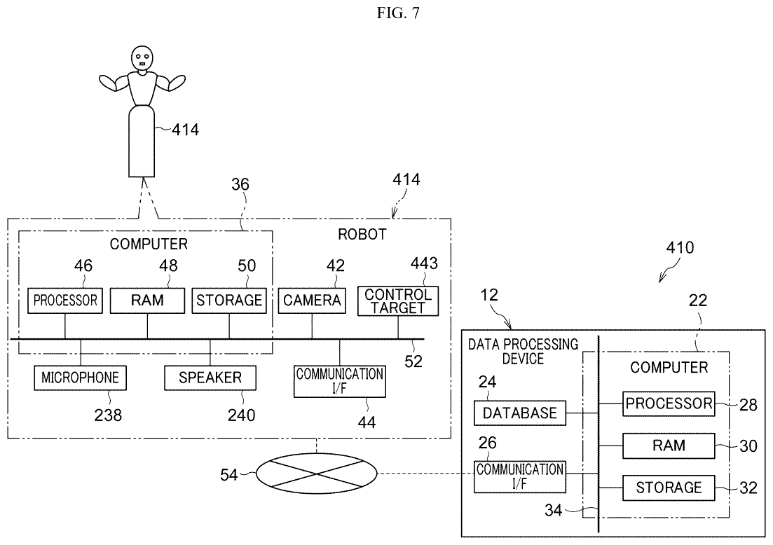

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

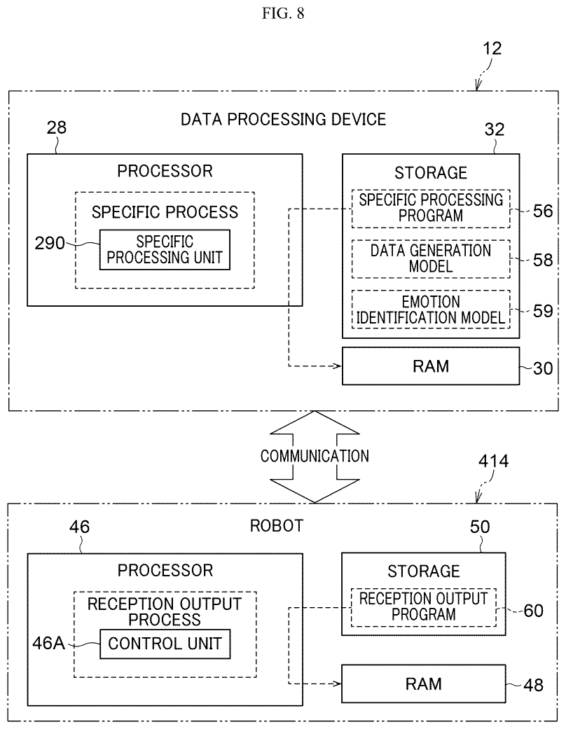

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

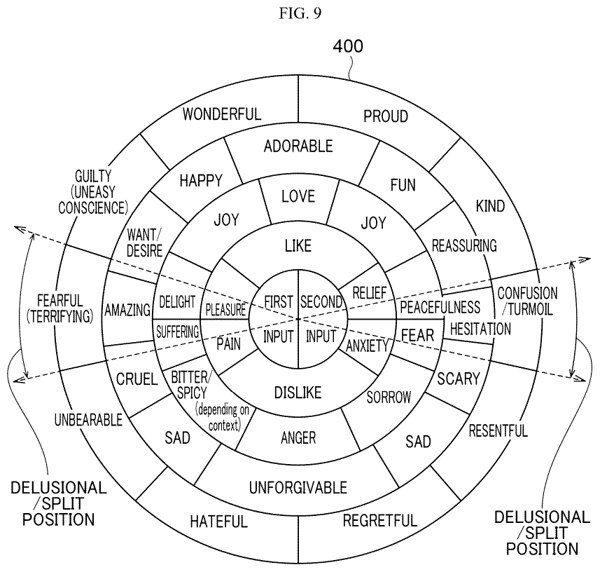

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

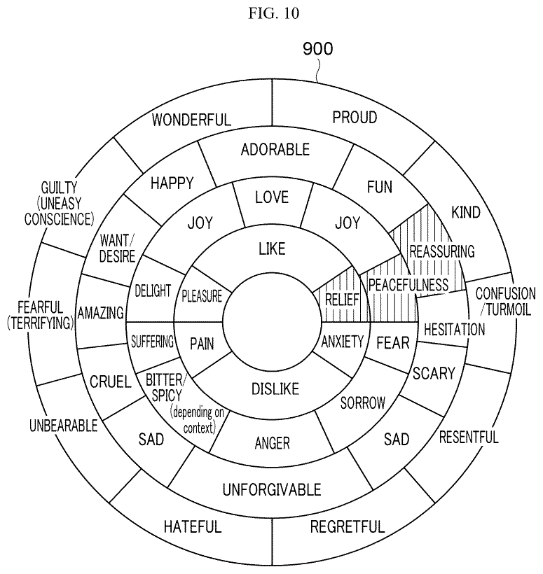

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire operation history data, search history data, and communication history data of a user, perform morphological analysis or statistical analysis on character information included in the acquired history data, and extract a group of keywords indicating an interest of the user, and execute an information collection process for automatically acquiring related information from information sources on a communication network on the basis of the group of keywords, and generate an information set including the related information, and
perform preprocessing for summarizing or formatting the information set, and generate a prompt sentence including instruction content, an output format, and neutrality conditions for a generative information processing model on the basis of the preprocessed information set and the group of keywords, and
input the prompt sentence and the information set to the generative information processing model, acquire generated information output from the generative information processing model, and generate an information medium corresponding to the interest of the user by summarizing or editing the generated information using natural language processing technology, and
generate notification data for distributing the information medium to a user terminal, and transmit the notification data to the user terminal via a communication service, and
update at least one of the group of keywords, the information collection process, and the prompt sentence on the basis of a usage state or evaluation information of the user acquired from the user terminal.

### Supplementary 2

The system according to supplementary 1,
wherein the processor is configured to
calculate importance levels of a plurality of information units included in the information set using the natural language processing technology in generating the information medium, and select or weight content to be input to the generative information processing model on the basis of the importance levels.

### Supplementary 3

The system according to supplementary 1,
wherein the processor is configured to
dynamically change a generation timing, a distribution frequency, or a notification format of the information medium on the basis of setting information of the user and the usage state, and adjust at least one of an output length, a structure, and a detail level condition included in the prompt sentence according to a content of the change.

### Application Example 1

### Supplementary 1

A system comprising a processor,
wherein the processor is configured to
acquire user behavior information and communication information, execute character string normalization processing and phrase extraction processing on text information including the user behavior information and the communication information, and generate interest information including phrases indicating a user interest target and an interest level associated with each of the phrases,
select, based on the interest information, a template that defines a type and a structure of a document medium or a video medium to be presented to a user, and construct a prompt sentence to be input to a generative AI model by embedding, into the template, instruction information including request contents for explanation, structural requirements, and expression conditions in accordance with the user interest target and the interest level,
input the prompt sentence to the generative AI model, acquire generated information including personalized explanatory information corresponding to the user interest target, and edit the generated information by using natural language processing so that the generated information has a neutral expression and a predetermined length while verifying the generated information for each structural unit,
execute voice generation processing and image selection processing or video composition processing on the edited generated information, generate medium data in a documentary format corresponding to the user interest target, convert the medium data into distribution data, and provide the distribution data to a user terminal via a communication network, and
acquire viewing history information and evaluation information transmitted from the user terminal, and update the interest information and configuration conditions of the prompt sentence based on the viewing history information and the evaluation information.

### Supplementary 2

The system according to supplementary 1,
wherein the processor is configured to
summarize text information included in the generated information, hierarchically rearrange the text information into chapter units, section units, or subsection units based on an importance index, and determine an explanatory structure to be included in the medium data.

### Supplementary 3

The system according to supplementary 1,
wherein the processor is configured to
change, dynamically, a notification frequency, a notification time, a medium type, and a presentation format when notifying the medium data or the generated information to the user terminal, based on user setting information and communication state information acquired from the user terminal, and reflect resulting viewing history information and evaluation information in updating the interest information and adjusting the configuration conditions of the prompt sentence.

### Example 2

### Supplementary 1

A system comprising a processor,
wherein the processor is configured to
acquire input information or behavior history information related to a user interest target and identify an interest of a user on the basis of the input information or the behavior history information,
acquire document information corresponding to the interest from an information communication network by using information acquisition software to obtain document information from a plurality of information sources, and format the document information as structured data,
generate a prompt sentence for a generative AI model on the basis of the interest and the structured data, input the prompt sentence and the structured data to the generative AI model, and cause the generative AI model to generate edited information including information that has been neutrally edited,
generate media configuration information including scene information, explanation text information, and visual element information on the basis of the edited information, and automatically generate visually attractive media content by using the media configuration information, and
distribute the media content to a terminal of the user and enable the media content to be displayed or reproduced on the terminal.

### Supplementary 2

The system according to supplementary 1,
wherein the processor is configured to
summarize the edited information in generating the media configuration information, classify the edited information into a plurality of sub-themes on the basis of importance of information and similarity of topics, and assign, for each of the sub-themes, a scene configuration, subtitle information, and visual element information.

### Supplementary 3

The system according to supplementary 1,
wherein the processor is configured to
update content of the prompt sentence input to the generative AI model or an information collection condition used by the information acquisition software, on the basis of viewing history information or feedback information acquired from the terminal of the user, and automatically adjust a configuration or a presentation format of media content to be generated subsequently.

### Application Example 2

### Supplementary 1

A system comprising a processor and a communication interface,
wherein the processor is configured to
analyze behavioral information and input information of a user to extract an interest subject of the user,
acquire emotional information of the user from a user terminal via the communication interface and identify an emotional state of the user based on the emotional information,
acquire related information from an information resource in accordance with the interest subject and the emotional state,
generate a prompt sentence including an editing policy corresponding to the interest subject and the emotional state, and input the prompt sentence to a generative AI model so as to cause the generative AI model to generate editing information,
generate neutral edited information by performing, on the basis of the editing information and the related information, natural language processing including at least summarizing, organizing according to importance, and reducing bias,
automatically generate an information medium including at least one of visual information and auditory information on the basis of the neutral edited information,
optimize contents or an expression mode of the information medium in accordance with the emotional state,
distribute the optimized information medium to the user terminal via a network using the communication interface and cause the user terminal to present the optimized information medium, and
update the interest subject and the editing policy based on at least one of a viewing history, an operation history, and evaluation information relating to the information medium, and personalize, on a continuous basis, the prompt sentence and the information medium to be generated thereafter.

### Supplementary 2

The system according to supplementary 1,
wherein the processor is configured to acquire document information from the information resource via the network as the related information, extract an important portion from the document information, and perform preprocessing of the important portion as input information to be supplied to the generative AI model.

### Supplementary 3

The system according to supplementary 1,
wherein the processor is configured to perform emotion analysis processing on at least one of image information and sound information acquired from the user terminal, and dynamically change at least one of an emotional tone, an amount of information, and a structure of the prompt sentence or the information medium based on a result of the emotion analysis processing.

What is claimed is:

1. A system comprising:
circuitry configured to:
acquire behavioral history data associated with an entity from a storage medium, the behavioral history data including interaction event records, query records, and content consumption records;
analyze the behavioral history data by applying a machine learning algorithm to compute interest profile data identifying one or more interest categories of the entity;
construct a parameterized instruction sequence based on the interest profile data, and provide the parameterized instruction sequence to a generative neural network model to cause the generative neural network model to generate content data based on the one or more interest categories; and
apply a natural language processing algorithm to the generated content data to perform neutrality editing processing including bias detection processing and style normalization processing to produce edited content data.

2. The system according to claim 1, wherein the machine learning algorithm comprises a feature extraction process that computes feature vectors from the behavioral history data by encoding interaction event types, query term frequencies, and content category identifiers, and a classification model that maps the feature vectors to the one or more interest categories based on learned weight parameters.

3. The system according to claim 2, wherein the classification model comprises a neural network having an input layer corresponding to dimensions of the feature vectors, one or more hidden layers with non-linear activation functions, and an output layer that computes probability distributions over a set of interest category labels.

4. The system according to claim 3, wherein the circuitry is further configured to:
apply a temporal weighting function to the behavioral history data such that more recent interaction event records contribute higher weight values to the feature vectors than older interaction event records.

5. The system according to claim 1, wherein the bias detection processing comprises applying a bias classification model to segments of the generated content data to identify segments having bias scores exceeding a bias threshold, and the style normalization processing comprises applying a rephrasing algorithm to the identified segments to replace biased expressions with neutral alternative expressions.

6. The system according to claim 5, wherein the bias classification model is trained using annotated training data comprising pairs of biased text segments and corresponding neutral text segments, with a loss function comprising a cross-entropy component between predicted bias labels and ground-truth bias labels.

7. The system according to claim 5, wherein the circuitry is further configured to:
apply a redundancy detection algorithm to the generated content data to identify and remove redundant information segments, and apply a relevance scoring algorithm to rank remaining segments by relevance to the interest profile data.

8. The system according to claim 1, wherein the circuitry is further configured to:
apply a summarization algorithm to the edited content data by constructing a summarization parameterized instruction sequence and providing it to the generative neural network model to generate summary data, and organize the edited content data based on importance scores computed for each content segment.

9. The system according to claim 8, wherein the importance scores are computed based on at least relevance to the interest profile data, recency of the underlying source data, and uniqueness relative to previously generated content data stored in the storage medium.

10. The system according to claim 1, wherein the circuitry is further configured to:
transmit the edited content data to a terminal apparatus via a packet-switched network, and adjust at least one of a transmission frequency parameter and a format parameter based on configuration data associated with the entity stored in the storage medium.

11. The system according to claim 10, wherein the format parameter specifies at least one of a text length constraint, a presentation layout specification, and a content section ordering specification, and wherein the circuitry adapts the edited content data to conform to the format parameter prior to transmission.

12. The system according to claim 1, wherein the generative neural network model comprises a transformer-based architecture including an embedding layer, a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

13. The system according to claim 12, wherein the parameterized instruction sequence includes a neutrality directive instructing the generative neural network model to avoid sensational language and to present multiple perspectives when generating content data related to topics having divergent viewpoints.

14. The system according to claim 12, wherein the circuitry is further configured to:
acquire image data and acoustic data associated with the entity from the terminal apparatus, apply an emotion estimation model to a combined feature vector derived from the image data and the acoustic data to compute emotion classification data, and incorporate the emotion classification data into the parameterized instruction sequence to cause the generative neural network model to adapt tone and emphasis of the content data based on the estimated emotional state.

15. The system according to claim 14, wherein the emotion estimation model comprises a multi-layer neural network having an input layer, one or more hidden layers, and an output layer that computes probability distributions over a set of emotion category labels.

16. The system according to claim 1, wherein the circuitry is further configured to:
receive feedback data from the terminal apparatus indicating entity engagement with the edited content data, update the behavioral history data in the storage medium based on the feedback data, and use the updated behavioral history data to refine subsequent computation of the interest profile data.

17. The system according to claim 16, wherein the circuitry is further configured to:
periodically retrain the machine learning algorithm using the accumulated behavioral history data to update weight parameters of the classification model, thereby improving accuracy of interest category identification over successive interactions.

18. A system comprising:
circuitry configured to:
acquire behavioral history data associated with an entity from a storage medium, and analyze the behavioral history data by applying a machine learning algorithm including feature extraction and classification to compute interest profile data;
construct a parameterized instruction sequence based on the interest profile data, and provide the parameterized instruction sequence to a generative neural network model having a transformer-based architecture including a plurality of self-attention layers to generate content data;
apply a natural language processing algorithm to the generated content data to perform bias detection processing and style normalization processing to produce edited content data;
apply a summarization algorithm to the edited content data and organize the edited content data based on importance scores; and
transmit the edited content data to a terminal apparatus via a packet-switched network with transmission parameters adjusted based on entity configuration data.

19. The system according to claim 18, wherein the circuitry is further configured to:
receive feedback data from the terminal apparatus, update the behavioral history data, and refine subsequent interest profile data computation to improve content relevance over successive interactions.

20. A method performed by circuitry, the method comprising:
acquiring behavioral history data associated with an entity from a storage medium, the behavioral history data including interaction event records, query records, and content consumption records;
analyzing the behavioral history data by applying a machine learning algorithm to compute interest profile data identifying one or more interest categories of the entity;
constructing a parameterized instruction sequence based on the interest profile data, and providing the parameterized instruction sequence to a generative neural network model to cause the generative neural network model to generate content data based on the one or more interest categories; and
applying a natural language processing algorithm to the generated content data to perform neutrality editing processing including bias detection processing and style normalization processing to produce edited content data.
